(19) United States
(12) Patent Application Publication
(10) Pub. No.: US 2026/0150110 A1
(43) Pub. Date: May 28, 2026

(54) RECEIVE/TRANSMIT PORT QUANTITY INDICATION

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/960,937

(22) Filed: Nov. 26, 2024

(51) Int. Cl. H04W 72/231; H04W 72/0446; H04W 72/1273; H04W 72/51

(52) U.S. Cl. CPC H04W 72/231; H04W 72/0446; H04W 72/1273; H04W 72/51

(57) ABSTRACT

Various aspects of the present disclosure generally relate to wireless communication. In some aspects, a user equipment (UE) may receive a receive/transmit port quantity indication, alone or in combination with a downlink control channel skip indication and/or a search space set group SSSG indication/switch indication simultaneously, wherein the receive/transmit port quantity indication indicates at least one of: a first quantity of receive ports to be used for monitoring a downlink control channel, or a second quantity of time intervals during which the first quantity of receive ports are to be used for monitoring the downlink control channel. The UE may monitor the downlink control channel based at least in part on the receive/transmit port quantity indication. Numerous other aspects are described.

### FIELD OF THE DISCLOSURE

Aspects of the present disclosure generally relate to wireless communication and specifically relate to techniques, apparatuses, and methods associated with a receive/transmit port quantity indication.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a user equipment (UE) operating in a wireless communication system may be configured to skip monitoring one or more downlink control channels or otherwise may be configured to monitor a selected subset of downlink control channels, such as for a purpose of conserving power at the UE. For example, a network node may signal to a UE a physical downlink control channel (PDCCH) skipping indication that indicates a certain quantity of time intervals (e.g., slots) during which the UE is to skip PDCCH monitoring. Additionally, or alternatively, the network node may signal to the UE a search space set group (SSSG) indication/switch indication that indicates a subset of PDCCHs that are to be monitored by the UE.

### SUMMARY

Some aspects described herein relate to a method of wireless communication performed by a user equipment (UE). The method may include receiving a receive/transmit port quantity indication, wherein the receive/transmit port quantity indication indicates at least one of a first quantity of receive ports to be used for monitoring a downlink control channel, or a second quantity of time intervals during which the first quantity of receive ports are to be used for monitoring the downlink control channel. The method may include monitoring the downlink control channel based at least in part on the receive/transmit port quantity indication.

Some aspects described herein relate to a method of wireless communication performed by a network node. The method may include transmitting, to a UE, a receive/transmit port quantity indication, wherein the receive/transmit port quantity indication indicates at least one of a first quantity of receive ports to be used by the UE for monitoring a downlink control channel, or a second quantity of time intervals during which the first quantity of receive ports are to be used by the UE for monitoring the downlink control channel. The method may include transmitting, to the UE, one or more downlink control communications using the downlink control channel.

Some aspects described herein relate to a UE for wireless communication. The UE may include one or more memories and one or more processors coupled to the one or more memories. The one or more processors may be configured to cause the UE to receive a receive/transmit port quantity indication, wherein the receive/transmit port quantity indication indicates at least one of a first quantity of receive ports to be used for monitoring a downlink control channel, or a second quantity of time intervals during which the first quantity of receive ports are to be used for monitoring the downlink control channel. The one or more processors may be configured to cause the UE to monitor the downlink control channel based at least in part on the receive/transmit port quantity indication.

Some aspects described herein relate to a network node for wireless communication. The network node may include one or more memories and one or more processors coupled to the one or more memories. The one or more processors may be configured to cause the network node to transmit, to a UE, a receive/transmit port quantity indication, wherein the receive/transmit port quantity indication indicates at least one of a first quantity of receive ports to be used by the UE for monitoring a downlink control channel, or a second quantity of time intervals during which the first quantity of receive ports are to be used by the UE for monitoring the downlink control channel. The one or more processors may be configured to cause the network node to transmit, to the UE, one or more downlink control communications using the downlink control channel.

Some aspects described herein relate to a non-transitory computer-readable medium that stores a set of instructions for wireless communication by a UE. The set of instructions, when executed by one or more processors of the UE, may cause the UE to receive a receive/transmit port quantity indication, wherein the receive/transmit port quantity indication indicates at least one of a first quantity of receive ports to be used for monitoring a downlink control channel, or a second quantity of time intervals during which the first quantity of receive ports are to be used for monitoring the downlink control channel. The set of instructions, when executed by one or more processors of the UE, may cause the UE to monitor the downlink control channel based at least in part on the receive/transmit port quantity indication.

Some aspects described herein relate to a non-transitory computer-readable medium that stores a set of instructions for wireless communication by a network node. The set of instructions, when executed by one or more processors of the network node, may cause the network node to transmit, to a UE, a receive/transmit port quantity indication, wherein the receive/transmit port quantity indication indicates at least one of a first quantity of receive ports to be used by the UE for monitoring a downlink control channel, or a second quantity of time intervals during which the first quantity of receive ports are to be used by the UE for monitoring the downlink control channel. The set of instructions, when executed by one or more processors of the network node, may cause the network node to transmit, to the UE, one or more downlink control communications using the downlink control channel.

Some aspects described herein relate to an apparatus for wireless communication. The apparatus may include means for receiving a receive/transmit port quantity indication, wherein the receive/transmit port quantity indication indicates at least one of a first quantity of receive ports to be used for monitoring a downlink control channel, or a second quantity of time intervals during which the first quantity of receive ports are to be used for monitoring the downlink control channel. The apparatus may include means for monitoring the downlink control channel based at least in part on the receive/transmit port quantity indication.

Some aspects described herein relate to an apparatus for wireless communication. The apparatus may include means for transmitting, to a UE, a receive/transmit port quantity indication, wherein the receive/transmit port quantity indication indicates at least one of a first quantity of receive ports to be used by the UE for monitoring a downlink control channel, or a second quantity of time intervals during which the first quantity of receive ports are to be used by the UE for monitoring the downlink control channel. The apparatus may include means for transmitting, to the UE, one or more downlink control communications using the downlink control channel.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3H are diagrams illustrating examples associated with downlink control channel selective monitoring, in accordance with the present disclosure.

FIGS. 4A-4C are diagrams of examples associated with receive/transmit port quantity indications, in accordance with the present disclosure.

FIG. 5 is a diagram illustrating an example process performed, for example, at a user equipment (UE) or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) operating in a wireless communication system may be configured to skip monitoring one or more downlink control channels or otherwise may be configured to monitor a selected subset of downlink control channels, such as for a purpose of conserving power at the UE. For example, a network node may signal, to a UE, a downlink control channel (e.g., a physical downlink control channel (PDCCH)) skipping indication that indicates a certain quantity of time intervals (e.g., slots) during which the UE is to skip PDCCH monitoring. Additionally, or alternatively, the network node may signal to the UE a search space set group (SSSG) indication/switch indication that indicates an SSSG (e.g., a subset of PDCCHs) that is to be used and/or switched to for PDCCH monitoring.

In some examples, skipping monitoring of certain PDCCHs, such as in response to receiving a PDCCH skipping indication and/or an SSSG indication/switch indication, may result in the UE missing certain control communications and/or may result in increased latency associated with certain communications. For example, in examples in which a UE is indicated to skip monitoring PDCCHs for a skip duration (e.g., X slots), if data is to be transmitted during the skip duration and/or if a corresponding scheduling communication is transmitted during the skip duration, the UE may miss the scheduling communication associated with the data, which may result in a high number of retransmissions and thus increased latency and/or increase network resource usage and thus reduce network throughput. In some other examples, if data is to be transmitted during the skip duration and/or if the network node is unable to send a scheduling communication via a PDCCH associated with an SSSG that is currently being monitored by the UE, the network node may delay transmitting a scheduling communication until after the skip duration and/or when a monitored PDCCH becomes available, resulting in increased latency associated with scheduling communications and otherwise inefficient usage of network resources.

Various aspects relate generally to a receive (Rx)/transmit (Tx) port quantity indication that is transmitted by a network node to a UE. Some aspects more specifically relate to a UE using a reduced quantity of Rx/Tx ports for monitoring downlink control channels, such for monitoring PDCCHs, in response to receiving a Rx/Tx port quantity indication from a network node. In some aspects, a network node may transmit, and a UE may receive, a Rx/Tx port quantity indication, which may indicate a quantity of Rx/Tx ports to be used by the UE for monitoring one or more control channels (e.g., one or more PDCCHs). The quantity of Rx ports and/or Tx ports may be less than all Rx ports and/or Tx ports associated with the UE. In some aspects, the UE may receive the Rx/Tx port quantity indication in combination with one or both of a downlink control channel skipping indication (e.g., a PDCCH skipping indication) and/or an SSSG indication/switch indication. For example, two or more of the Rx/Tx port quantity indication, the downlink control channel skipping indication, and/or the SSSG indication/switch indication may be jointly indicated using a codepoint signaled via lower-layer signaling (e.g., via a downlink control information (DCI) message and/or a medium access control (MAC) control element (MAC-CE), among other examples).

Particular aspects of the subject matter described in this disclosure can be implemented to realize one or more of the following potential advantages. In some examples, the described techniques can be used to reduce power consumption at the UE. For example, when the UE is indicated to use less than all Rx ports and/or Tx ports for PDCCH monitoring, the UE may consume less power resources than would otherwise have been consumed by the UE using all Rx/Tx ports for PDCCH monitoring. Moreover, enabling the network node to transmit the Rx/Tx port quantity indication in combination with one or both of the downlink control channel skipping indication and/or the SSSG indication/switch indication may result in more flexible PDCCH monitoring adaptation at the UE. For example, the various indications may enable adaptation of PDCCH monitoring behavior in the time domain and/or spatial domain in response to varying traffic and/or channel conditions, resulting in more efficient usage of power, computing, and network resources.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

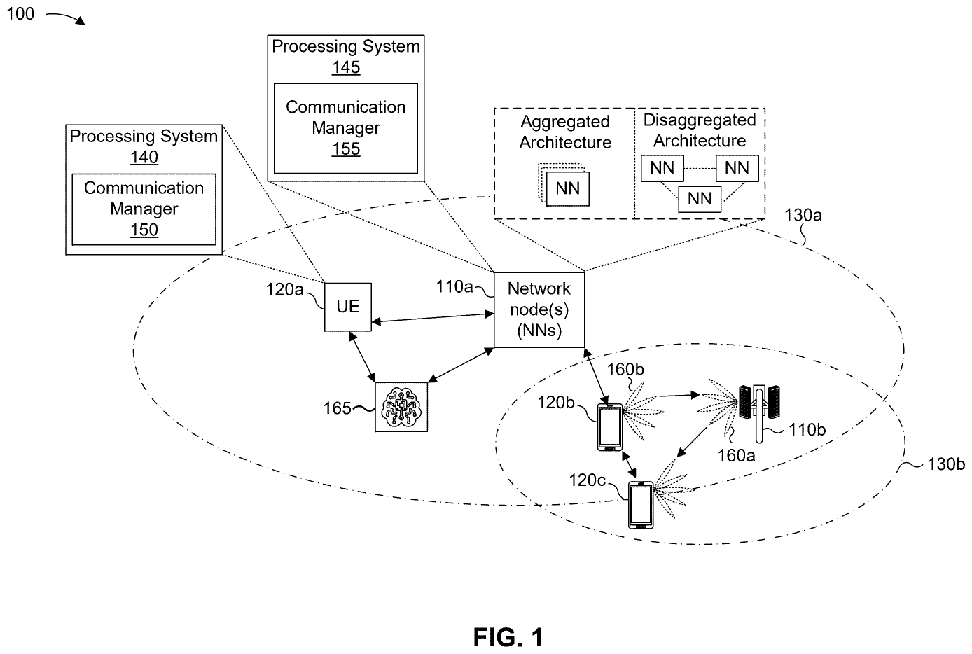

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR 1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

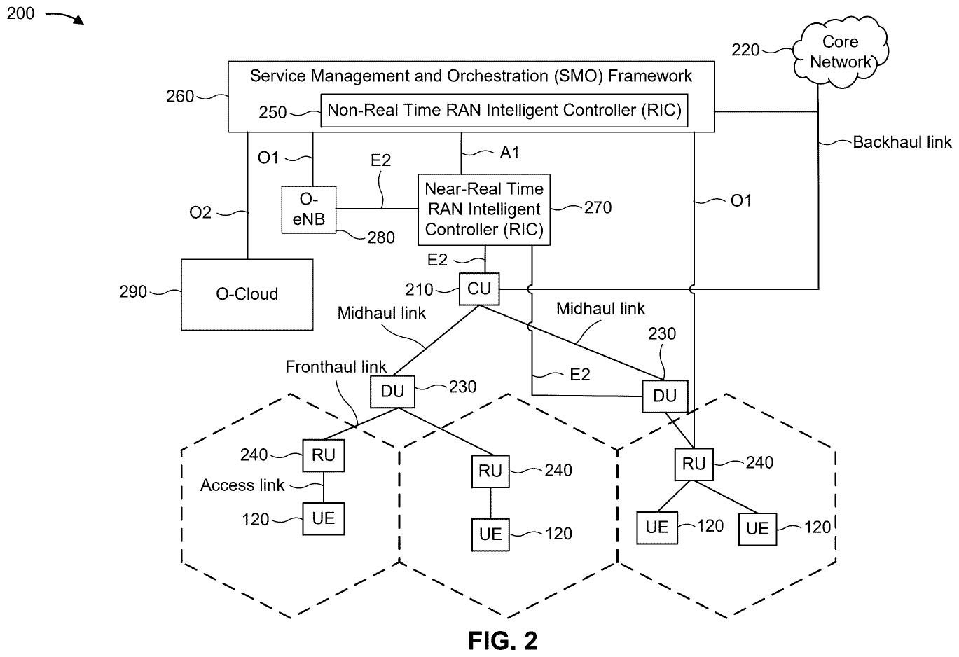

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components and/or ports, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

NES and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, among other examples which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a RAN, which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand SSB transmission, antenna port adaptation, advanced CSI reporting, and/or power-efficient paging reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, receive/transmit ports, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some aspects, the UE 120 may include a communication manager 150. As described in more detail elsewhere herein, the communication manager 150 may receive a receive/transmit port quantity indication, wherein the receive/transmit port quantity indication indicates at least one of: a first quantity of receive ports to be used for monitoring a downlink control channel, or a second quantity of time intervals during which the first quantity of receive ports are to be used for monitoring the downlink control channel; and monitor the downlink control channel based at least in part on the receive/transmit port quantity indication. Additionally, or alternatively, the communication manager 150 may perform one or more other operations described herein.

In some aspects, the network node 110 may include a communication manager 155. As described in more detail elsewhere herein, the communication manager 155 may transmit, to a UE, a receive/transmit port quantity indication, wherein the receive/transmit port quantity indication indicates at least one of: a first quantity of receive ports to be used by the UE for monitoring a downlink control channel, or a second quantity of time intervals during which the first quantity of receive ports are to be used by the UE for monitoring the downlink control channel; and transmit, to the UE, one or more downlink control communications using the downlink control channel. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

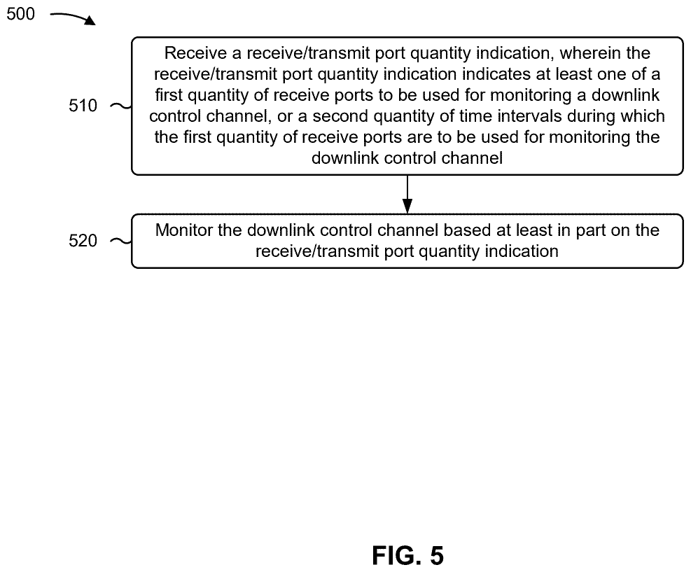

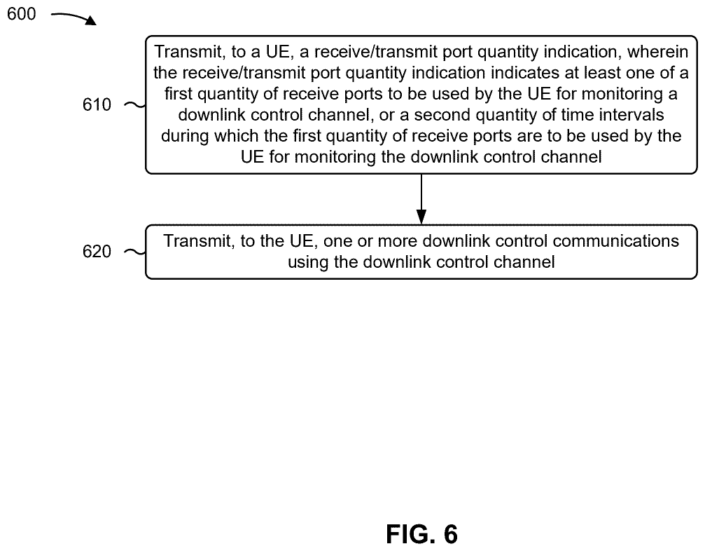

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a Rx/Tx port quantity indication, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

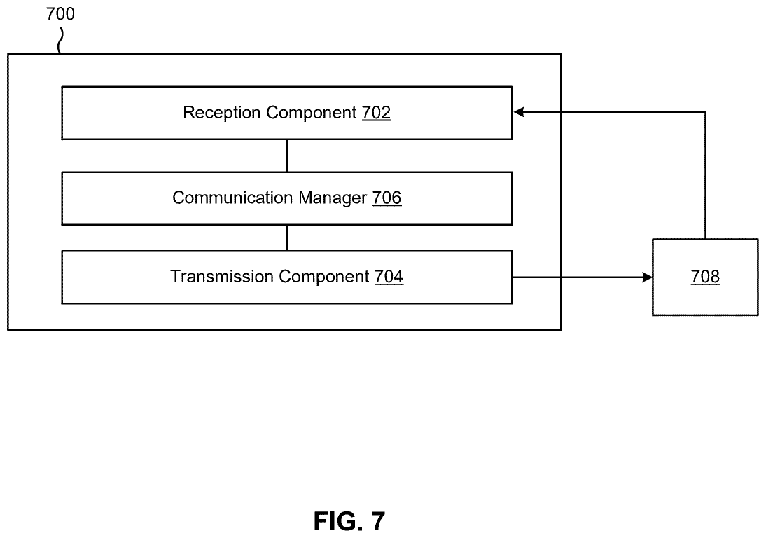

In some aspects, the UE 120 includes means for receiving a Rx/Tx port quantity indication, wherein the Rx/Tx port quantity indication indicates at least one of: a first quantity of receive ports to be used for monitoring a downlink control channel, or a second quantity of time intervals during which the first quantity of receive ports are to be used for monitoring the downlink control channel; and/or means for monitoring the downlink control channel based at least in part on the Rx/Tx port quantity indication. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

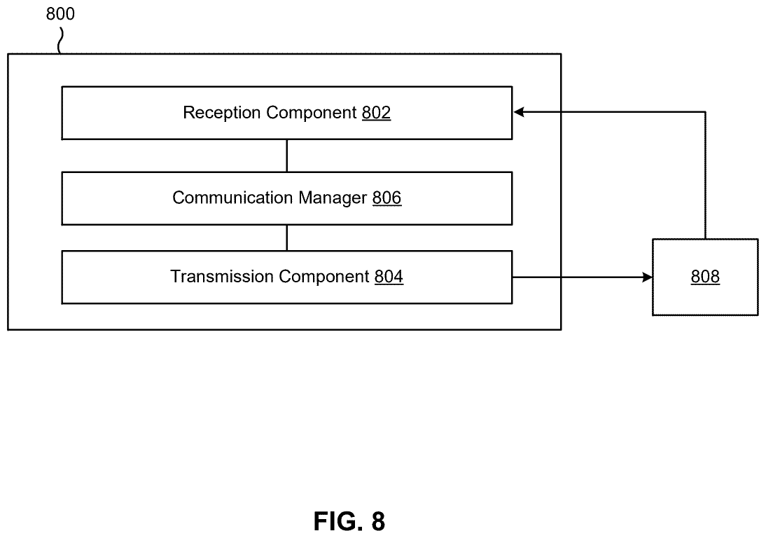

In some aspects, the network node 110 includes means for transmitting, to a UE, a Rx/Tx port quantity indication, wherein the Rx/Tx port quantity indication indicates at least one of: a first quantity of receive ports to be used by the UE for monitoring a downlink control channel, or a second quantity of time intervals during which the first quantity of receive ports are to be used by the UE for monitoring the downlink control channel; and/or means for transmitting, to the UE, one or more downlink control communications using the downlink control channel. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

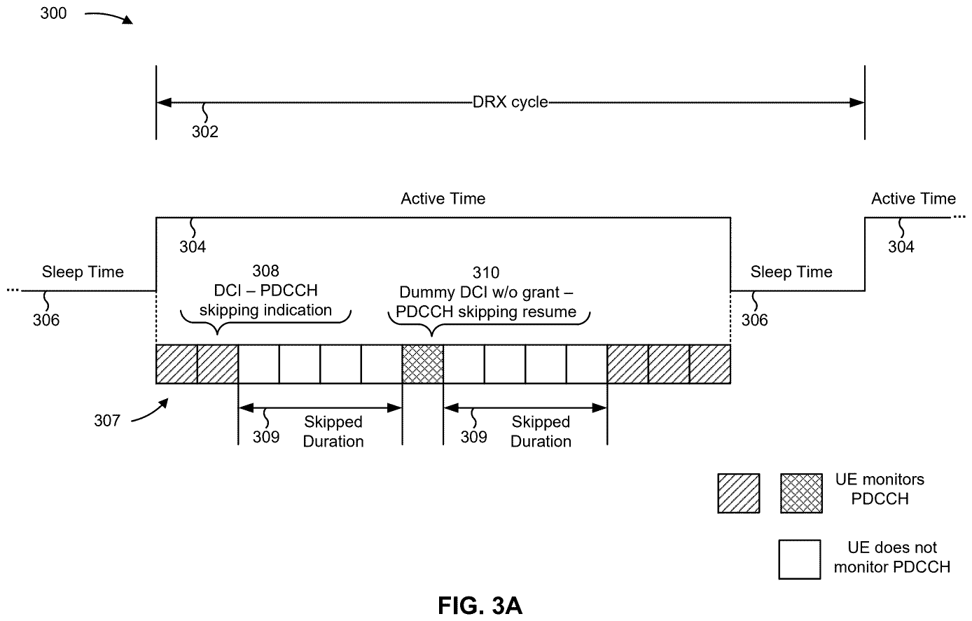

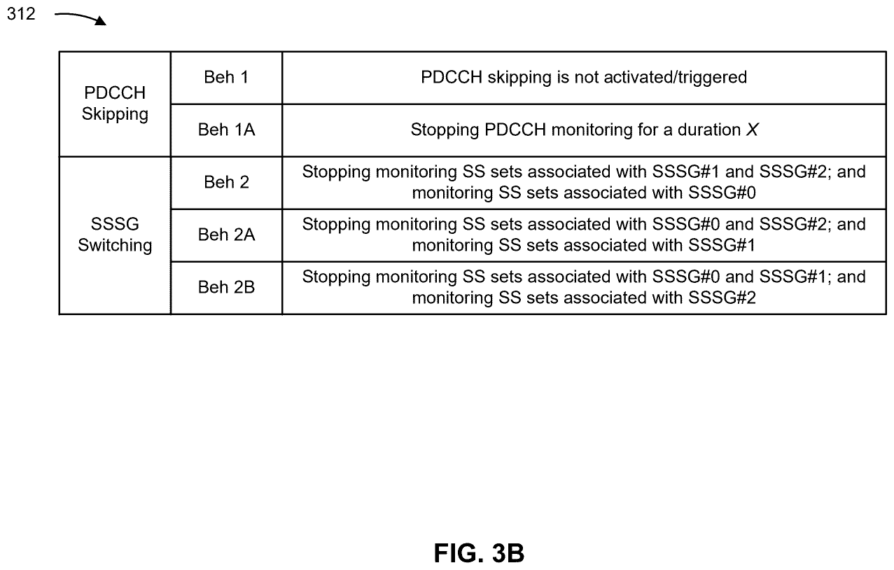

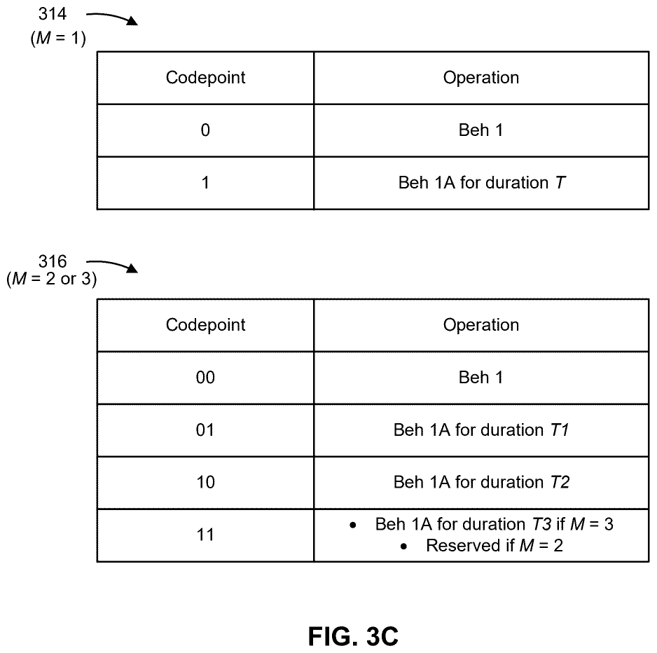

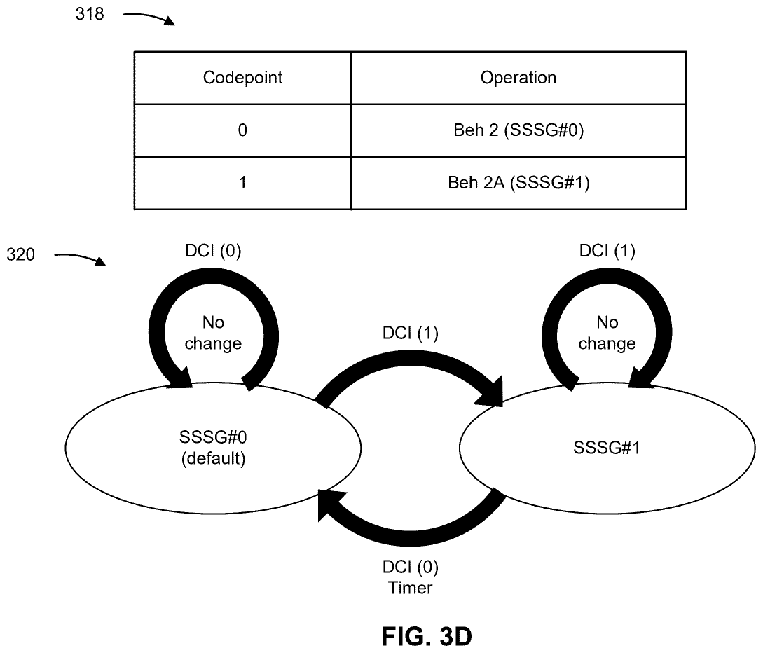

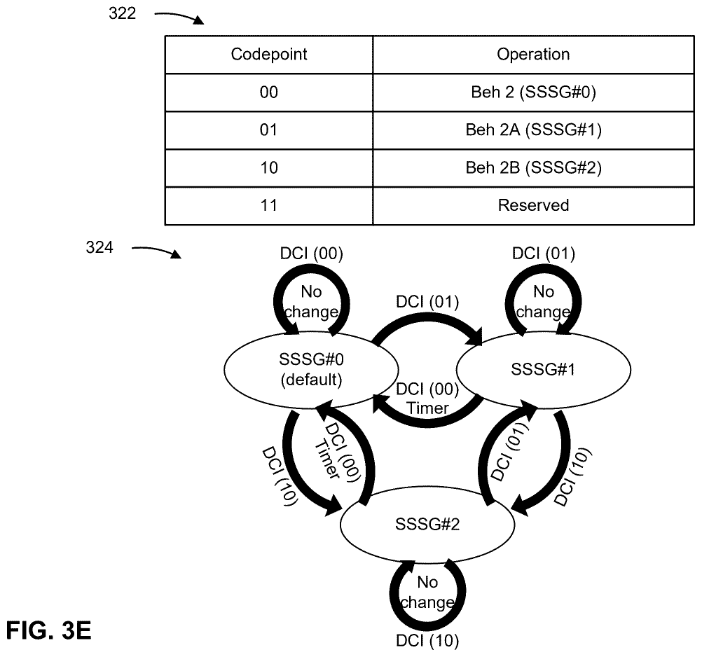

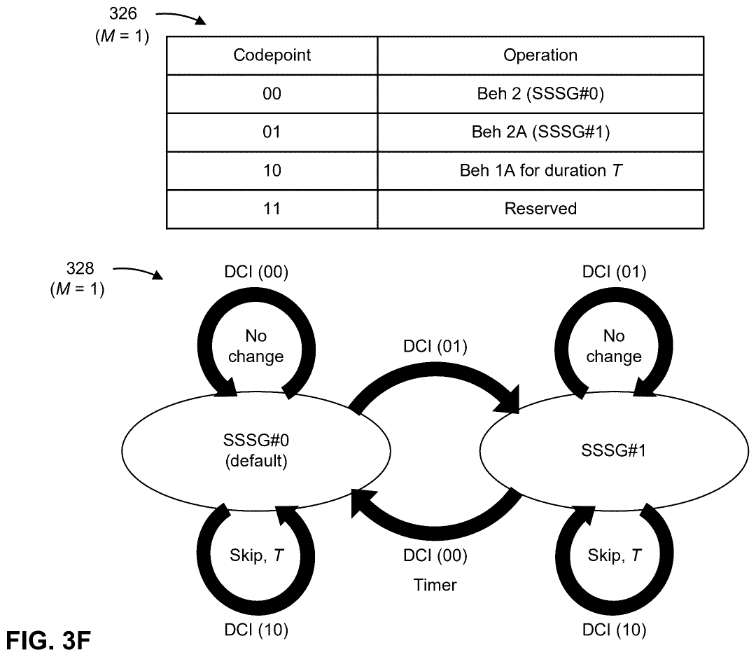

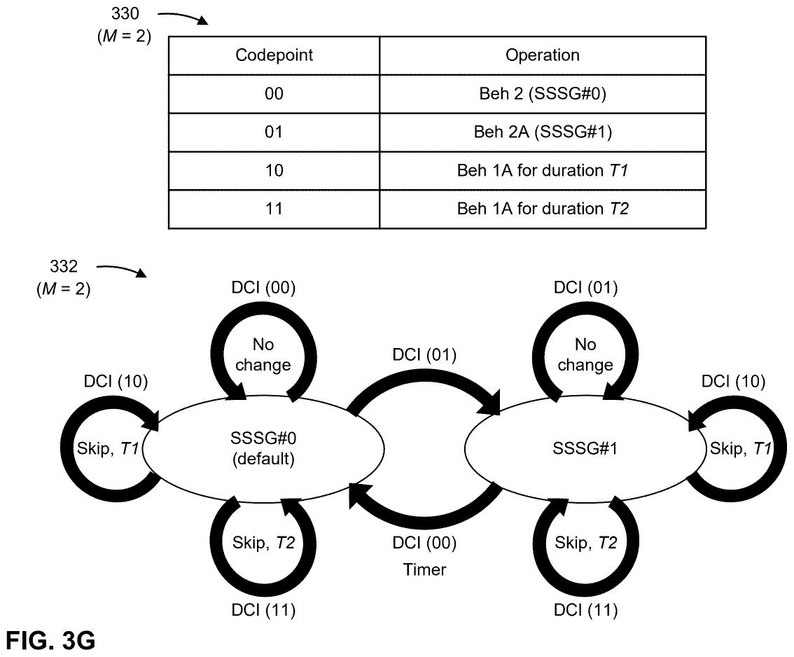

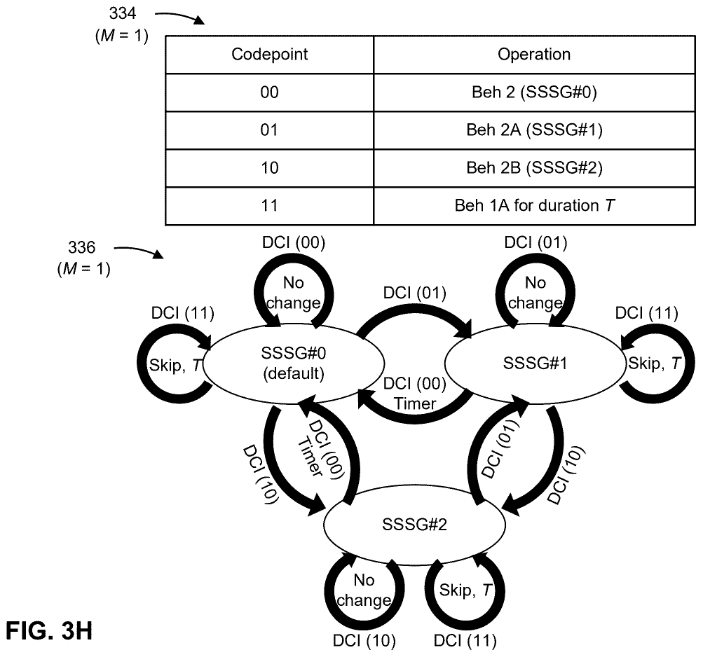

FIGS. 3A-3H are diagrams illustrating examples associated downlink control channel selective monitoring, in accordance with the present disclosure.

In some examples, a major portion of UE power consumption while a UE is in an RRC connected mode may be attributed to the UE decoding downlink control channel (e.g., PDCCH) communications that are not needed by the UE (e.g., that do not include any uplink or downlink grant associated with the UE). Accordingly, in some examples, a UE may be configured to skip downlink control channel monitoring (e.g., the UE may be configured to skip PDCCH monitoring) and/or may be configured to selectively monitor only certain downlink control channels (e.g., certain PDCCHs associated with an indicated SSSG), such as for a purpose of reducing power consumption at the UE, among other examples.

More particularly, FIG. 3A shows an example 300 associated with PDCCH skipping that may be performed by a UE (e.g., UE 120). As shown in FIG. 3A, a UE may be configured with a DRX cycle 302 (e.g., a connected mode DRX (C-DRX) cycle), which may include an active time 304 and a sleep time 306. As indicated by the boxes shown by reference number 307, the active time 304 may be associated with multiple control channel occasions, such as multiple PDCCH occasions (sometimes referred to herein simply as “PDCCHs” for ease of description). If the UE were to monitor and/or decode each of the PDCCHs, even PDCCHs which are not necessary for the UE because there is no uplink or downlink grant for the UE, among other examples, the UE may be associated with high power consumption. Accordingly, the network node may configure the UE to skip monitoring a certain quantity of PDCCHs, such as when there is no expected control information to be sent to the UE.

More particularly, as indicated using hatching in FIG. 3A, the UE may monitor certain PDCCHs, such as the first two PDCCHs shown in FIG. 3A. As indicated by reference number 308, using a PDCCH that is monitored by the UE (e.g., the second PDCCH in FIG. 3A), the network node may transmit a PDCCH skipping indication, such as by transmitting a DCI that includes a PDCCH skipping field, among other examples. Put another way, the network node may notify the UE to perform PDCCH skipping if there is no data to be transmitted to the UE. Upon receipt of the PDCCH skipping indication, the UE may stop monitoring a certain quantity of PDCCHs, such as for a purpose of saving power. For example, as shown in FIG. 3A, the PDCCH skipping indication may indicate that the UE may skip monitoring PDCCHs for a certain period of time and/or a certain quantity of time intervals (e.g., a certain quantity of slots), among other examples, shown as a skipped duration 309 in FIG. 3A. Accordingly, as shown by using no shading in connection with the PDCCHs corresponding to the skipped duration 309, the UE may omit monitoring and/or decoding PDCCHs during the skipped duration 309, thereby conserving power resources at the UE.

As indicated by using cross-hatching in FIG. 3A, upon expiration of the skipped duration 309, the UE may once again monitor a PDCCH. If at that point there is data to be transmitted to the UE, among other examples, the network node may transmit control information to the UE using the monitored PDCCH, such as a scheduling communication to schedule the data transfer. However, if there is no data to be transmitted after expiration of the skipped duration 309, the network node may transmit a communication (e.g., a DCI communication, sometimes referred to as a dummy DCI) without a grant and/or that indicates that PDCCH skipping is to be resumed by the UE, as indicated by reference number 310. In such examples, the UE may again skip monitoring PDCCHs for a certain period of time and/or a certain quantity of time intervals (e.g., a certain quantity of slots), such as for the skipped duration 309 shown in FIG. 3A. The process may repeat itself, such that, upon expiration of the second instance of the skipped duration 309, the UE may once again monitor a PDCCH and either receive a grant (e.g., when there is data to be transmitted) or a dummy DCI (e.g., when there is no data to be transmitted), and the UE may proceed accordingly.

Additionally, or alternatively, a UE may be configured to monitor a subset of search spaces (SSs) configured for the UE in order to reduce a quantity of PDCCHs to be monitored by the UE and/or to conserve power resources at the UE. A SS is a set of PDCCH candidates (e.g., PDCCH monitoring occasions) where a UE searches for DCI. The UE may be configured to monitor one or more SSs, such as by the network node transmitting an indication of an SSSG (e.g., a group of one or more SSs) that is to be monitored by the UE. In some examples, a UE may switch between SSSGs. For example, a UE may be configured with up to three SSSGs, sometimes referred to herein as SSSG #0, SSSG #1, and SSSG #2. In some other examples, the UE may be configured with more or fewer SSSGs. DCI-based SSSG switching may be supported for RRC connected UEs, such that the network node may dynamically indicate to the UE which SSSG is to be monitored. For example, SSSG #0 may correspond to all SSs that are configured for the UE, SSSG #1 may correspond to a first proper subset of the SSs that are configured for the UE (e.g., SSSG #1 may include less than all of the SSs that are configured for the UE), and/or SSSG #2 may correspond to a second proper subset of the SSs that are configured for the UE (e.g., SSSG #2 may include less than all of the SSs that are configured for

the UE, which may be a different subset of SSs than are included in SSSG #1), among other examples.

As shown in FIG. 3B, and as indicated by reference number 312, in some examples the UE may be configured to perform PDCCH monitoring using one or more of multiple candidate behaviors, such as one of behavior 1 (shown in FIG. 3B as “Beh 1”), behavior 1A (shown in FIG. 3B as “Beh 1A”), behavior 2 (shown in FIG. 3B as “Beh 2”), behavior 2A (shown in FIG. 3B as “Beh 2A”), or behavior 2B (shown in FIG. 3B as “Beh 2B”), among other examples. As further shown in FIG. 3B, behaviors 1 and 1A may be associated with PDCCH skipping, while behaviors 2, 2A, and 2B may be associated with SSSG switching.

More particularly, behavior 1 may be associated with PDCCH skipping not being activated and/or triggered. Accordingly, when a codepoint of a scheduling DCI indicates behavior 1, the UE may be indicated to monitor all PDCCH occasions. Behavior 1A may be associated with PDCCH skipping being activated and/or triggered, such that the UE stops PDCCH monitoring for a certain duration (e.g., X slots). In some aspects, the UE may further be indicated with the value of X among M configured values (e.g., M RRC configured values), with a maximum value of M being three in some examples. Put another way, in some examples a skip duration may be indicated by a DCI communication using two bits, with up to three values of X being configured for the UE (e.g., M≤3). In some aspects, X may correspond to a quantity of slots that is less than or equal to 100 millisecond (ms). In that regard, the supported values of X may be {1, 2, 3, . . ., 20, 30, 40, 50, 60, 80, 100} for an SCS of 15 kilohertz (kHz), {1, 2, 3, . . . , 40, 60, 80,100, 120, 160, 200} for an SCS of 30 kHz, {1, 2, 3, . . . , 80, 120, 160, 200, 240, 320, 400} for a SCS of 60 kHz, and/or {1, 2, 3, . . . , 160, 240, 320, 400, 480, 640, 800} for an SCS of 120 kHz, among other examples. In some examples, a UE may be configured with a PDCCH skipping duration per BWP. Additionally, or alternatively, a UE may always monitor and/or decode certain types of PDCCH and/or DCI communications, regardless of whether the UE is configured to perform PDCCH skipping. For example, in some examples monitoring Type0/0A/1/2 control SS (CSS) may not be affected by PDCCH skipping, monitoring of DCI format 2_6 (e.g., a DCI communication associated with a wake-up signal (WUS)) in Type3 CSS outside DRX active time may not be affected by PDCCH skipping, and/or monitoring of DCI formats 0_0/1_0 with cell radio network temporary identifier (C-RNTI), MCS-C-RNTI, or configured scheduling RNTI (CS-RNTI) in Type0/0A/1/2 CSS may not be affected by PDCCH skipping.

Behavior 2 may be associated with the UE stopping monitoring SS sets associated with SSSG #1 and SSSG #2 and/or with the UE monitoring SS sets associated with SSSG #0. Similarly, behavior 2A may be associated with the UE stopping monitoring SS sets associated with SSSG #0 and SSSG #2 and/or with the UE monitoring SS sets associated with SSSG #1. Moreover, behavior 2B may be associated with the UE stopping monitoring SS sets associated with SSSG #0 and SSSG #1 and/or with the UE monitoring SS sets associated with SSSG #2.

Using a scheduling DCI, a network node may indicate which of the candidate behaviors the UE is to apply. Put another way, one or more of the candidate behaviors shown in FIG. 3B may be mapped to a codepoint of an indication field in the scheduling DCI (e.g., a PDCCH skipping field of the scheduling DCI) such that the network node may indicate which behavior is to be applied by signaling the corresponding codepoint.

For example, as shown in FIG. 3C, and as indicated by reference number 314, in some examples a scheduling DCI may include a one-bit field to indicate which candidate PDCCH skipping behavior the UE is to apply when M=1. In such examples, when the indication field (e.g., the PDCCH skipping field) of the scheduling DCI indicates codepoint 0, the UE may be indicated to apply behavior 1, and/or when the indication field of the scheduling DCI indicates codepoint 1, the UE may be indicated to apply behavior 1A for a duration of T (with T being the one configured value corresponding to M=1).

Moreover, as further shown in FIG. 3C, and as indicated by reference number 316, in some other examples a scheduling DCI may include a two-bit field to indicate which candidate PDCCH skipping behavior the UE is to apply when M=2 or 3. In such examples, when the indication field (e.g., the PDCCH skipping field) of the scheduling DCI indicates codepoint 00, the UE may be indicated to apply behavior 1. When the indication field of the scheduling DCI indicates codepoint 01, the UE may be indicated to apply behavior 1A for a duration of T1, with T1 being the first of the two or three configured values corresponding to M=2 or 3. When the indication field of the scheduling DCI indicates codepoint 10, the UE may be indicated to apply behavior 1A for a duration of T2, with T2 being the second of the two or three configured values corresponding to M=2 or 3. When the indication field of the scheduling DCI indicates codepoint 11, the UE may be indicated to apply behavior 1A for a duration of T3, with T3 being the third of the three configured values corresponding to M=3 (with codepoint 11 being reserved in examples in which M=2).

In some other examples, as shown in FIG. 3D, and as indicated by reference number 318, a scheduling DCI may include a one-bit field to indicate which candidate SSSG switching behavior the UE is to apply, such as in examples associated with two candidate SSSGs (e.g., SSSG #0 and SSSG #1). In such examples, when the indication field (e.g., the PDCCH skipping field) of the scheduling DCI indicates codepoint 0, the UE may be indicated to apply behavior 2 (e.g., stop monitoring SSSG #1 and monitor SSSG #0), and/or when the indication field of the scheduling DCI indicates codepoint 1, the UE may be indicated to apply behavior 2A (e.g., stop monitoring SSSG #0 and monitor SSSG #1).

In that regard, and as indicated by reference number 320, by default the UE may monitor SSSG #0. If, while monitoring SSSG #0, the UE receives a scheduling DCI in which the indication field indicates codepoint 0, the UE may continue to monitor SSSG #0 (as shown via the arrow labeled “no change” in connection with SSSG #0). However, if, while monitoring SSSG #0, the UE receives a scheduling DCI in which the indication field indicates codepoint 1, the UE may switch to monitoring SSSG #1 (as shown via the arrow labeled “DCI (1)” extending between SSSG #0 and SSSG #1). If, while monitoring SSSG #1, the UE receives a scheduling DCI in which the indication field indicates codepoint 1, the UE may continue to monitor SSSG #1 (as shown via the arrow labeled “no change” in connection with SSSG #1). However, if, while monitoring SSSG #1, the UE receives a scheduling DCI in which the indication field indicates codepoint 0 and/or if a timer expires (which may be an RRC configured timer), the UE may switch to monitoring SSSG #0 (as shown via the arrow labeled “DCI (0) Timer” extending between SSSG #1 and SSSG #0).

In some other examples, as shown in FIG. 3E, and as indicated by reference number 322, a scheduling DCI may include a two-bit field to indicate which candidate SSSG switching behavior the UE is to apply, such as in examples associated with three candidate SSSGs (e.g., SSSG #0, SSSG #1, and SSSG #2). In such examples, when the indication field (e.g., the PDCCH skipping field) of the scheduling DCI indicates codepoint 00, the UE may be indicated to apply behavior 2 (e.g., stop monitoring SSSG #1 and SSSG #2 and monitor SSSG #0). When the indication field of the scheduling DCI indicates codepoint 01, the UE may be indicated to apply behavior 2A (e.g., stop monitoring SSSG #0 and SSSG #2 and monitor SSSG #1). And when the indication field of the scheduling DCI indicates codepoint 10, the UE may be indicated to apply behavior 2B (e.g., stop monitoring SSSG #0 and SSSG #1 and monitor SSSG #2). In such examples, codepoint 11 may be reserved.

In that regard, and as indicated by reference number 324, by default the UE may monitor SSSG #0. If, while monitoring SSSG #0, the UE receives a scheduling DCI in which the indication field indicates codepoint 00, the UE may continue to monitor SSSG #0 (as shown via the arrow labeled “no change” in connection with SSSG #0). However, if, while monitoring SSSG #0, the UE receives a scheduling DCI in which the indication field indicates codepoint 01, the UE may switch to monitoring SSSG #1 (as shown via the arrow labeled “DCI (01)” extending between SSSG #0 and SSSG #1). On the other hand, if, while monitoring SSSG #0, the UE receives a scheduling DCI in which the indication field indicates codepoint 10, the UE may switch to monitoring SSSG #2 (as shown via the arrow labeled “DCI (10)” extending between SSSG #0 and SSSG #2).

If, while monitoring SSSG #1, the UE receives a scheduling DCI in which the indication field indicates codepoint 01, the UE may continue to monitor SSSG #1 (as shown via the arrow labeled “no change” in connection with SSSG #1). However, if, while monitoring SSSG #1, the UE receives a scheduling DCI in which the indication field indicates codepoint 00 and/or if a timer expires, the UE may switch to monitoring SSSG #0 (as shown via the arrow labeled “DCI (00) Timer” extending between SSSG #1 and SSSG #0). On the other hand, if, while monitoring SSSG #1, the UE receives a scheduling DCI in which the indication field indicates codepoint 10, the UE may switch to monitoring SSSG #2 (as shown via the arrow labeled “DCI (10)” extending between SSSG #1 and SSSG #2).

Similarly, if, while monitoring SSSG #2, the UE receives a scheduling DCI in which the indication field indicates codepoint 10, the UE may continue to monitor SSSG #2 (as shown via the arrow labeled “no change” in connection with SSSG #2). However, if, while monitoring SSSG #2, the UE receives a scheduling DCI in which the indication field indicates codepoint 00 and/or if a timer expires, the UE may switch to monitoring SSSG #0 (as shown via the arrow labeled “DCI (00) Timer” extending between SSSG #2 and SSSG #0). On the other hand, if, while monitoring SSSG #2, the UE receives a scheduling DCI in which the indication field indicates codepoint 01, the UE may switch to monitoring SSSG #1 (as shown via the arrow labeled “DCI (01)” extending between SSSG #2 and SSSG #1).

In some other examples, a DCI indicator field may be used to indicate a combination of SSSG switching and PDCCH skipping behaviors to be applied by the UE. For example, as shown in FIG. 3F, and as indicated by reference number 326 a scheduling DCI may include a two-bit field to indicate which candidate SSSG switching behavior the UE is to apply, with or without PDCCH skipping (with M=1 in this example), such as in examples associated with two candidate SSSGs (e.g., SSSG #0 and SSSG #1). In such examples, when the indication field (e.g., the PDCCH skipping field) of the scheduling DCI indicates codepoint 00, the UE may be indicated to apply behavior 2 (e.g., stop monitoring SSSG #1 and monitor SSSG #0), and/or when the indication field of the scheduling DCI indicates codepoint 01, the UE may be indicated to apply behavior 2A (e.g., stop monitoring SSSG #0 and monitor SSSG #1). Moreover, when the indicator field indicates 10, the UE may be indicated to apply behavior 1A for a duration T (e.g., skip monitoring PDCCHs for a duration T, with T corresponding to the one configured skip duration in this example). Codepoint 11 may be reserved in this example.

In that regard, and as indicated by reference number 328, by default the UE may monitor SSSG #0. If, while monitoring SSSG #0, the UE receives a scheduling DCI in which the indication field indicates codepoint 00, the UE may continue to monitor SSSG #0 (as shown via the arrow labeled “no change” in connection with SSSG #0). If, while monitoring SSSG #0, the UE receives a scheduling DCI in which the indication field indicates codepoint 10, the UE may skip monitoring PDCCHs for duration T (as shown via the arrow labeled “Skip, T” in connection with SSSG #0). Moreover, if, while monitoring SSSG #0, the UE receives a scheduling DCI in which the indication field indicates codepoint 01, the UE may switch to monitoring SSSG #1 (as shown via the arrow labeled “DCI (01)” extending between SSSG #0 and SSSG #1).

If, while monitoring SSSG #1, the UE receives a scheduling DCI in which the indication field indicates codepoint 01, the UE may continue to monitor SSSG #1 (as shown via the arrow labeled “no change” in connection with SSSG #1). Moreover, if, while monitoring SSSG #1, the UE receives a scheduling DCI in which the indication field indicates codepoint 10, the UE may skip monitoring PDCCHs for duration T (as shown via the arrow labeled “Skip, T” in connection with SSSG #1). And if, while monitoring SSSG #1, the UE receives a scheduling DCI in which the indication field indicates codepoint 00 and/or if a timer expires (which may be an RRC configured timer), the UE may switch to monitoring SSSG #0 (as shown via the arrow labeled “DCI (00) Timer” extending between SSSG #1 and SSSG #0).

In some other examples, as shown in FIG. 3G, and as indicated by reference number 330, a scheduling DCI may include a two-bit field to indicate which candidate SSSG switching behavior the UE is to apply, with or without PDCCH skipping (with M=2 in this example), such as in examples associated with two candidate SSSGs (e.g., SSSG #0 and SSSG #1). In such examples, when the indication field (e.g., the PDCCH skipping field) of the scheduling DCI indicates codepoint 00, the UE may be indicated to apply behavior 2 (e.g., stop monitoring SSSG #1 and monitor SSSG #0), and/or when the indication field of the scheduling DCI indicates codepoint 01, the UE may be indicated to apply behavior 2A (e.g., stop monitoring SSSG #0 and monitor SSSG #1). Moreover, when the indicator field indicates 10, the UE may be indicated to apply behavior 1A for a duration T1 (e.g., skip monitoring PDCCHs for a duration T1, with T1 corresponding to a first configured skip duration of two configured skip durations in this example), and when the indicator field indicates 11, the UE may be indicated to apply behavior 1A for a duration T2 (e.g., skip monitoring PDCCHs for a duration T2, with T2 corresponding to a second configured skip duration of two configured skip durations in this example).

In that regard, and as indicated by reference number 332, by default the UE may monitor SSSG #0. If, while monitoring SSSG #0, the UE receives a scheduling DCI in which the indication field indicates codepoint 00, the UE may continue to monitor SSSG #0 (as shown via the arrow labeled “no change” in connection with SSSG #0). If, while monitoring SSSG #0, the UE receives a scheduling DCI in which the indication field indicates codepoint 10, the UE may skip monitoring PDCCHs for duration T1 (as shown via the arrow labeled “Skip, T1” in connection with SSSG #0). Similarly, if, while monitoring SSSG #0, the UE then receives a scheduling DCI in which the indication field indicates codepoint 11, the UE may skip monitoring PDCCHs for duration T2 (as shown via the arrow labeled “Skip, T2” in connection with SSSG #0). Moreover, if, while monitoring SSSG #0, the UE receives a scheduling DCI in which the indication field indicates codepoint 01, the UE may switch to monitoring SSSG #1 (as shown via the arrow labeled “DCI (01)” extending between SSSG #0 and SSSG #1).

If, while monitoring SSSG #1, the UE receives a scheduling DCI in which the indication field indicates codepoint 01, the UE may continue to monitor SSSG #1 (as shown via the arrow labeled “no change” in connection with SSSG #1). If, while monitoring SSSG #1, the UE then receives a scheduling DCI in which the indication field indicates codepoint 10, the UE may skip monitoring PDCCHs for duration T1 (as shown via the arrow labeled “Skip, T1” in connection with SSSG #1). Similarly, if, while monitoring SSSG #0, the UE receives a scheduling DCI in which the indication field indicates codepoint 11, the UE may skip monitoring PDCCHs for duration T2 (as shown via the arrow labeled “Skip, T2” in connection with SSSG #1). And if, while monitoring SSSG #0, the UE receives a scheduling DCI in which the indication field indicates codepoint 00 and/or if a timer expires (which may be an RRC configured timer), the UE may switch to monitoring SSSG #0 (as shown via the arrow labeled “DCI (00) Timer” extending between SSSG #1 and SSSG #0).

In some other examples, as shown in FIG. 3H, and as indicated by reference number 334, a scheduling DCI may include a two-bit field to indicate which candidate SSSG switching behavior the UE is to apply, with or without PDCCH skipping (with M=1 in this example), such as in examples associated with three candidate SSSGs (e.g., SSSG #0, SSSG #1, and SSSG #2). In such examples, when the indication field (e.g., the PDCCH skipping field) of the scheduling DCI indicates codepoint 00, the UE may be indicated to apply behavior 2 (e.g., stop monitoring SSSG #1 and SSSG #2 and monitor SSSG #0). When the indication field of the scheduling DCI indicates codepoint 01, the UE may be indicated to apply behavior 2A (e.g., stop monitoring SSSG #0 and SSSG #2 and monitor SSSG #1). When the indication field of the scheduling DCI indicates codepoint 10, the UE may be indicated to apply behavior 2B (e.g., stop monitoring SSSG #0 and SSSG #1 and monitor SSSG #0). And when the indication field of the scheduling DCI indicates codepoint 11, the UE may be indicated to apply behavior 1A for duration T (e.g., skip PDCCH monitoring for duration T).

In that regard, and as indicated by reference number 336, by default the UE may monitor SSSG #0. If, while monitoring SSSG #0, the UE receives a scheduling DCI in which the indication field indicates codepoint 00, the UE may continue to monitor SSSG #0 (as shown via the arrow labeled “no change” in connection with SSSG #0). If, while monitoring SSSG #0, the UE receives a scheduling DCI in which the indication field indicates codepoint 11, the UE may skip monitoring PDCCHs for duration T (as shown via the arrow labeled “Skip, T” in connection with SSSG #0). If, while monitoring SSSG #0, the UE receives a scheduling DCI in which the indication field indicates codepoint 01, the UE may switch to monitoring SSSG #1 (as shown via the arrow labeled “DCI (01)” extending between SSSG #0 and SSSG #1). And if, while monitoring SSSG #0, the UE receives a scheduling DCI in which the indication field indicates codepoint 10, the UE may switch to monitoring SSSG #2 (as shown via the arrow labeled “DCI (10)” extending between SSSG #0 and SSSG #2).

If, while monitoring SSSG #1, the UE receives a scheduling DCI in which the indication field indicates codepoint 01, the UE may continue to monitor SSSG #1 (as shown via the arrow labeled “no change” in connection with SSSG #1). If, while monitoring SSSG #1, the UE receives a scheduling DCI in which the indication field indicates codepoint 11, the UE may skip monitoring PDCCHs for duration T (as shown via the arrow labeled “Skip, T” in connection with SSSG #1). However, if, while monitoring SSSG #1, the UE receives a scheduling DCI in which the indication field indicates codepoint 00 and/or if a timer expires, the UE may switch to monitoring SSSG #0 (as shown via the arrow labeled “DCI (00) Timer” extending between SSSG #1 and SSSG #0). On the other hand, if, while monitoring SSSG #1, the UE receives a scheduling DCI in which the indication field indicates codepoint 10, the UE may switch to monitoring SSSG #2 (as shown via the arrow labeled “DCI (10)” extending between SSSG #1 and SSSG #2).

Similarly, if, while monitoring SSSG #2, the UE receives a scheduling DCI in which the indication field indicates codepoint 10, the UE may continue to monitor SSSG #2 (as shown via the arrow labeled “no change” in connection with SSSG #2). If, while monitoring SSSG #2, the UE receives a scheduling DCI in which the indication field indicates codepoint 11, the UE may skip monitoring PDCCHs for duration T (as shown via the arrow labeled “Skip, T” in connection with SSSG #2). However, if, while monitoring SSSG #2, the UE receives a scheduling DCI in which the indication field indicates codepoint 00 and/or if a timer expires, the UE may switch to monitoring SSSG #0 (as shown via the arrow labeled “DCI (00) Timer” extending between SSSG #2 and SSSG #0). On the other hand, if, while monitoring SSSG #2, the UE receives a scheduling DCI in which the indication field indicates codepoint 01, the UE may switch to monitoring SSSG #1 (as shown via the arrow labeled “DCI (01)” extending between SSSG #2 and SSSG #1).

In some examples, skipping monitoring of certain PDCCHs, such as in response to receiving a PDCCH skipping indication and/or an SSSG indication/switch indication, may result in the UE missing certain control communications or may result in increased latency associated with certain communications. For example, in examples in which a UE is indicated to skip monitoring PDCCHs for a skip duration (e.g., X slots), if data is to be transmitted during the skip duration, the UE may miss a scheduling communication associated with the data, which may result in a high number of retransmissions and thus increased latency and/or reduced throughput. On the other hand, the network node may delay transmitting a scheduling communication until after the skip duration, resulting in increased latency and otherwise inefficient usage of network resources.

Some techniques described herein enable a UE to use a reduced quantity of Rx/Tx ports for monitoring PDCCHs. In some aspects, a network node may transmit, and a UE may receive, a Rx/Tx port quantity indication, which may indicate a quantity of Rx/Tx ports to be used by the UE for monitoring one or more control channels (e.g., one or more PDCCHs). The quantity of Rx/Tx ports may be less than all Rx ports and/or Tx ports associated with the UE, resulting in less power usage than would otherwise have been consumed by the UE using all Rx/Tx ports to monitor PDCCHs. For example, monitoring and/or decoding PDCCHs using one Rx port may result in much less power consumption than monitoring and/or decoding PDCCHs using two or four Rx ports. In some aspects, the UE may receive the Rx/Tx port quantity indication in combination with one or both of a PDCCH skipping indication and/or an SSSG indication/switch indication. In such aspects, the UE may use less power than would have otherwise been consumed monitoring PDCCHs when indicated using only the PDCCH skipping indication and/or the SSSG indication/switch indication. Moreover, enabling the network node to transmit the Rx/Tx port quantity indication in combination with one or both of a PDCCH skipping indication and/or an SSSG indication/switch indication may result in more flexible PDCCH monitoring adaptation at the UE, resulting in more efficient usage of power, computing, and network resources.

As indicated above, FIGS. 3A-3H are provided as examples. Other examples may differ from what is described with respect to FIGS. 3A-3H.

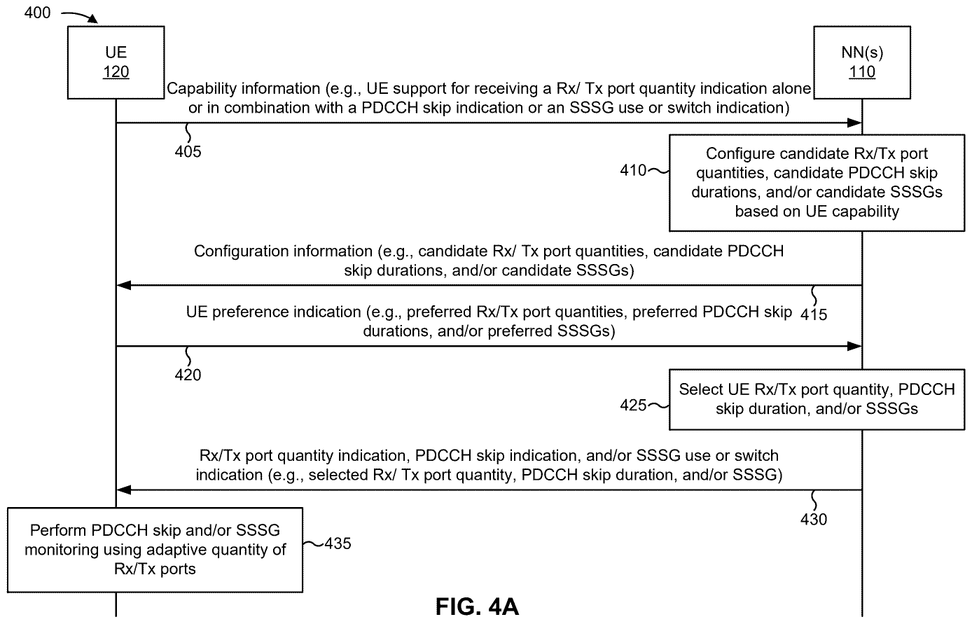

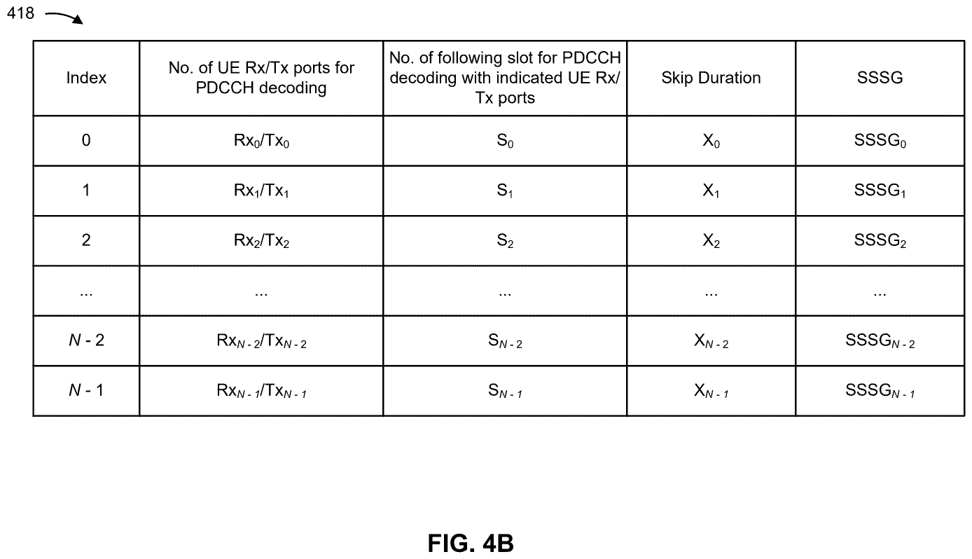

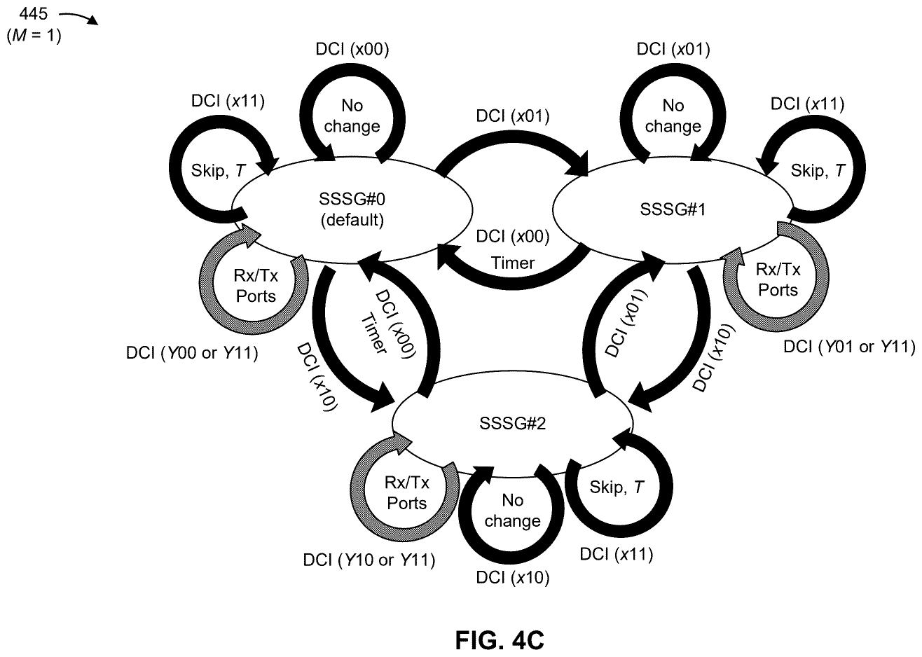

FIGS. 4A-4C are diagrams of examples associated with Rx/Tx port quantity indications, in accordance with the present disclosure. As shown in FIG. 4A, and as indicated by reference number 400, a network node 110 (e.g., a CU, a DU, and/or an RU) may communicate with a UE 120. In some aspects, the network node 110 and the UE 120 may be part of a wireless network (e.g., wireless communication network 100). The UE 120 and the network node 110 may have established a wireless connection prior to operations shown in FIG. 4A.

As shown by reference number 405, the UE 120 may transmit, and the network node 110 may receive, capability information (e.g., a capabilities report). The capability information may indicate whether the UE 120 supports a feature and/or one or more parameters related to the feature. For example, the capability information may indicate a capability and/or parameter for receiving indications associated with reduced PDCCH monitoring. As another example, the capability information may indicate a capability and/or parameter for monitoring control channels (e.g., PDCCHs) using a reduced quantity of Rx/Tx ports. One or more operations described herein may be based on capability information. For example, the UE 120 may perform a communication in accordance with the capability information, or may receive configuration information that is in accordance with the capability information.

In some aspects, the capability information may indicate UE support for receiving a Rx/Tx port quantity indication (e.g., an indication that indicates a quantity of Rx ports and/or Tx ports to be used for monitoring a downlink control channel (e.g., a PDCCH) and/or a quantity of time intervals during which the quantity of Rx ports and/or Tx ports are to be used for monitoring the downlink control channel, which is described in more detail below in connection with reference number 430). Put another way, in some aspects, the UE 120 may indicate (e.g., via the signaling shown in connection with reference number 405) the UE 120's capability to support reception of an Rx/Tx port quantity indication for PDCCH decoding.

Additionally, or alternatively, the capability information may indicate UE support for receiving the Rx/Tx port quantity indication in combination with at least one of a downlink control channel skip indication (e.g., a PDCCH skip indication) and/or an SSSG indication/switch indication (e.g., an indication that indicates an SSSG to be used or switched to for PDCCH monitoring).

As shown by reference number 410, in aspects in which the capability information indicates UE support for receiving the Rx/Tx port quantity indication, the network node 110 may configure candidate Rx/Tx port quantities to be used by the UE 120 for monitoring a downlink control channel (e.g., a PDCCH). Put another way, the network node 110 may configure a pool of Rx/Tx port quantity indications for PDCCH decoding based at least in part on the UE 120's capability. Moreover, in aspects in which the capability information further indicates UE support for receiving the Rx/Tx port quantity indication in combination with the at least one of the downlink control channel skip indication (e.g., the PDCCH skip indication) and/or the SSSG indication/switch indication, the network node may configure one or more candidate quantities of time intervals to be signaled by the downlink control channel skip indication and/or one or more candidate SSSGs to be signaled by the SSSG indication/switch indication. Put another way, in connection with the operations indicated by reference number 410, the network node 110 may configure a pool of PDCCH skip durations, a pool SSSGs, and/or a pool of Rx/Tx port quantity indications for PDCCH decoding based at least in part on the on UE capability

As shown by reference number 415, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein, such as one the indication described below in connection with reference number 430) may include a dynamic indication, such as one or more MAC-CEs and/or one or more DCI messages, among other examples.

In some aspects, such as in aspects in which the capability information indicates UE support for receiving the Rx/Tx port quantity indication, the configuration information may enable transmission and reception of the Rx/Tx quantity indication, the may indicate one or more candidate quantities of Rx ports and/or Tx ports to be signaled by the Rx/Tx port quantity indication, and/or the may indicate one or more candidate quantities of time intervals to be signaled by the Rx/Tx port quantity indication. For example, the configuration information may indicate multiple indexes and/or codepoints that could be later signaled by the network node, and, for each index and/or codepoint, a quantity of Rx ports to be used by the UE 120 PDCCH monitoring (which may be less than all Rx ports associated with the UE 120, as described above), a quantity of Tx ports to be used by the UE 120 when monitoring PDCCHs (which may be less than all Tx ports associated with the UE 120 and/or which may be a same or different quantity as the quantity of Rx ports associated with that index), and/or a duration (e.g., a quantity of slots) during which the UE 120 is to use the corresponding quantity of Rx ports and/or Tx ports. For example, the configuration information may configure a table of candidate Rx/Tx port quantities and associated durations, such as a table indicating that a first index is associated with the UE 120 using one Rx port and one Tx port for a duration of two slots, a second index is associated with the UE 120 using one Rx port and two Tx ports for a duration of four slots, a third index is associated with the UE 120 using one Rx port and four Tx ports for a duration of eight slots, a fourth index associated with the UE 120 using two Rx ports and two Tx ports for a duration of two slots, and so forth. In such aspects, the network node 110 may later signal (e.g., using DCI or a MAC-CE, among other examples) which of the indexes is to be applied by the UE 120, which is described in more detail below in connection with reference number 430.

In aspects in which the capability information indicates UE support for receiving the downlink control channel skip indication (e.g., the PDCCH skip indication) and/or the SSSG indication/switch indication in combination with the Rx/Tx port quantity indication, the configuration information may further enable one or both of the downlink control channel skip indication and/or the SSSG indication/switch indication. Additionally, or alternatively, the configuration information may indicate candidate parameters associated with each enabled indication, such as one or more candidate quantities of time intervals to be signaled by the downlink control channel skip indication and/or one or more candidate SSSGs to be signaled by the SSSG indication/switch indication. In such examples, the configuration information may configure a table of candidate Rx/Tx port quantities and associated durations, each with a corresponding PDCCH skip duration and/or SSSG to be monitored.

For example, FIG. 4B shows a table 418 including information that may be indicated to the UE 120 via the configuration information. As shown in FIG. 4B, the table 418 may include multiple (e.g., N) indexes, shown in FIG. 4B as index 0 through index N-1. For each index, the table 418 indicates a corresponding quantity of Rx/Tx ports to be used by the UE 120 for PDCCH monitoring (shown in table 418 as Rxᵢ/Txᵢ, with i corresponding to the corresponding index in table 418), a corresponding quantity of time intervals (e.g., slots) during which the UE 120 is to use the indicated quantity of Rx/Tx ports (shown as Sᵢ in table 418), a corresponding skip duration during which the UE 120 is to skip PDCCH monitoring (shown as Xᵢ in table 418), and/or a corresponding SSSG that the UE is to use for PDCCH monitoring (shown as SSSGᵢ in table 418). In such aspects, when a scheduling communication or similar dynamic communication (e.g., the communication described below in connection with reference number 430) indicates a codepoint associated with index 0, the UE 120 may be signaled to perform PDCCH monitoring using a quantity of Rx ports indicated by Rx₀ and a quantity of Tx ports indicated by Tx₀ (with Rx₀ and Tx₀ being the same or different quantities), to use the quantity of Rx ports indicated by Rx₀ and the quantity of Tx ports indicated by Tx₀ for a duration indicated by S₀, to skip PDCCH monitoring for a quantity of time intervals indicated by X₀, and/or to perform PDCCH monitoring using an SSSG indicated by SSSG₀. In some aspects, a scheduling communication or similar dynamic communication may indicate a codepoint corresponding to one of the indexes using an n-bit field, where 2ⁿ=N (which is described in more detail below in connection with reference number 430).

The UE 120 may configure itself based at least in part on the configuration information. In some aspects, the UE 120 may be configured to perform one or more operations described herein based at least in part on the configuration information.

In some aspects, the configuration information described in connection with reference number 415 and/or the capability information described above in connection with reference number 405 may include information transmitted via multiple communications. Additionally, or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

Returning to FIG. 4A, and as indicated by 420, in some aspects the UE 120 may transmit, and the network node 110 may receive, a UE preference indication. The UE preference indication may indicate one or more preferred configuration parameters to be selected and/or indicated by the network node 110. For example, in some aspects, the UE preference indication may indicate a preferred quantity of Rx ports to be used for monitoring the downlink control channel, a preferred quantity of Tx ports to be used when monitoring the downlink control channel, and/or a preferred quantity of time intervals during which the preferred quantity of Rx ports and/or Tx ports are to be used for monitoring the downlink control channel. For example, based at least in part on a traffic prediction performed by the UE 120 (e.g., using an AI/ML component of the UE 120), a channel-conditions prediction performed by the UE 120 (e.g., using the AI/ML component of the UE 120), or a similar prediction, the UE 120 may determine preferred Rx/Tx port quantities to be used for PDCCH monitoring and/or a preferred duration for using the preferred Rx/Tx port quantities, and thus the UE may may signal such preferences to the network node 110.

For example, in aspects in which the UE 120 predicts (e.g., using an AI/ML model, among other examples) relatively low traffic, that data communications are not likely to be scheduled in the near future, and/or relatively stable channel conditions, the UE 120 may indicate a relatively small quantity of Rx/Tx ports be used for PDCCH monitoring and/or that reduced quantities of Rx/Tx ports are to be used for a relatively long duration (e.g., in order to maximize power savings benefits at the UE 120). On the other hand, in aspects in which the UE 120 predicts relatively high traffic, that data communications are likely to be scheduled in the near future, and/or relatively unstable channel conditions, the UE 120 may indicate a relatively large quantity of Rx/Tx ports be used for PDCCH monitoring and/or that reduced quantities of Rx/Tx ports are to be used for a relatively short duration (e.g., in order to ensure upcoming control messages are successfully received and/or to reduce communication errors and thus associated retransmissions).

In some other aspects, the UE 120 may indicate additional preferences via the UE preference indication, such as preferences associated with PDCCH skipping and/or SSSG selection. Put another way, in some aspects the UE preference indication may indicate indicates a preference for receiving, in combination (e.g., jointly via a single codepoint or the like), one or more of the Rx/Tx port quantity indication, the downlink control channel skip indication, or the SSSG indication/switch indication. Additionally, or alternatively, the UE preference indication may indicate one or more preferred parameters associated with the Rx/Tx port quantity indication, the downlink control channel skip indication, and/or the SSSG indication/switch indication (e.g., a preferred Rx/Tx port quantity, a preferred duration for using the preferred Rx/Tx port quantity, a preferred PDCCH skip duration, a preferred SSSG to be monitored, and/or similar preferred parameters). In some aspects, the UE preference indication may indicate an index and/or codepoint from a table of candidate configurations, such as the table 418 described above in connection with FIG. 4B. For example, based at least in part on a traffic prediction performed by the UE 120 (e.g., using an AI/ML component of the UE 120) and/or a similar prediction, the UE 120 may determine a preferred configuration from the table 418 described above in connection with FIG. 4B, and/or the UE may may signal, to the network node 110, a codepoint associated with an index of the preferred configuration.

As indicated by reference number 425, the network node 110 may select one or more configuration parameters associated with downlink control channel monitoring to be performed by the UE 120. For example, in aspects in which the network node 110 configured the UE 120 with a table of candidate Rx/Tx port quantity indications, candidate downlink control channel skipping indications, and/or candidate SSSG indication/switch indications (such as via the table 418 described above in connection with FIG. 4B), the network node 110 may select an entry of the table to be indicated to the UE 120. In some aspects, the network node 110 may select an entry that strikes a balance between maximizing power savings benefits at the UE 120 while ensuring that the UE 120 does not miss important control information that may need to be communicated in the future. In some aspects, such as aspects in which the UE 120 transmits the UE preference indication described above in connection with reference number 420, the network node 110 may select one or more configuration parameters associated with downlink control channel (e.g., PDCCH) monitoring to be performed by the UE 120 based at least in part on the UE preference indication. For example, the network node 110 may select the index indicated by the UE preference indication, among other examples.

As indicated by reference number 430, the network node 110 may transmit, and the UE 120 may receive, a Rx/Tx port quantity indication (e.g., an indication indicating a quantity of Rx ports to be used for monitoring a downlink control channel (e.g., a PDCCH), a quantity of Tx ports to be used when monitoring the downlink control channel, and/or a quantity of time intervals (e.g., slots) during which the quantity of Rx ports and/or the quantity of Tx ports are to be used for monitoring the downlink control channel). In some aspects, the Rx/Tx port quantity indication may indicate the quantity of Rx/Tx ports and the quantity of time intervals by indicating a codepoint that jointly encodes the quantity of Rx/Tx ports and the quantity of time intervals. For example, the UE 120 may be configured (e.g., via the configuration information described above in connection with reference number 415) with a table indicating multiple codepoints and/or indexes, with each codepoint and/or index being associated with a respective Rx port quantity, a respective Tx port quantity, and/or a respective time interval for using the respective Rx port quantity and/or the respective Tx port quantity. In such aspects, the Rx/Tx port quantity indication may indicate the codepoint and/or index of the selected configuration.

In some aspects, the Rx/Tx port quantity indication may be associated with lower-layer signaling, such as DCI and/or a MAC-CE, among other examples, while, in some other aspects, the Rx/Tx port quantity indication may be associated with an expiration of a timer (e.g., which may be substantially similar to the timer described above in connection with FIGS. 3D-3H). For example, in some aspects the Rx/Tx port quantity indication may be received via a DCI message that indicates the codepoint (e.g., a codepoint indicating the Rx port quantity, the Tx port quantity, and/or the quantity of time intervals) via a downlink control channel skipping indication (e.g., a PDCCH skipping indication) associated with the DCI message. Put another way, the PDCCH skipping bits of the scheduling DCIs described above in connection with FIGS. 3A-3H may be reused to select a Rx/Tx port quantity configuration from a pool of candidate Rx/Tx port quantity configurations. In some other aspects, the Rx/Tx port quantity indication may be received via a MAC-CE, such as a newly defined MAC-CE for a purpose of providing Rx/Tx port quantity indications. For example, in some aspects, the Rx/Tx port quantity indication may be received via a MAC-CE that indicates the codepoint via a logical channel identifier (LCH ID) associated with the MAC-CE.

In some aspects, such as in aspects in which the UE 120 has a capability of receiving a downlink control channel skip indication (e.g., a PDCCH skip indication) and/or an SSSG indication/switch indication in combination with the Rx/Tx port quantity indication (e.g., aspects in which the UE 120 has a capability of receiving a codepoint that jointly encodes at least two of the Rx/Tx port quantity indication, the downlink control channel indication, and/or the SSSG indication/switch indication), the network node 110 may transmit, and the UE 120 may receive, in combination with the Rx/Tx port quantity indication (e.g., jointly encoded with the Rx/Tx port quantity indication), the downlink control channel skip indication (e.g., an indication that indicates a quantity of time intervals (e.g., slots) to be skipped when monitoring the downlink control channel) and/or the SSSG indication/switch indication (e.g., an indication that indicates an SSSG to be used or switched to when monitoring the downlink control channel). For example, the network node 110 may signal a codepoint corresponding to one of the indexes of the table 418 described above in connection with FIG. 4B.

As indicated by reference number 435, the UE 120 may monitor the downlink control channel based at least in part on the Rx/Tx port quantity indication, the downlink control channel skip indication, and/or the SSSG indication/switch indication. In this way, the network node 110 may indicate, simultaneously, PDCCH skipping and/or SSSG indication/switching using an adaptive quantity of Rx/Tx ports. For example, the indication shown by reference number 430 may indicate, in slot N, that the UE 120 is to use a reduced quantity of Rx and/or Tx ports for purposes of PDCCH monitoring over a certain quantity (e.g., n) slots following slot N, that the UE 120 may skip monitoring certain ones of those n slots, and/or that the UE 120 may monitor and/or decode only PDCCHs that are associated with a certain SSSG. In this way, the network node 110 may essentially indicate a combination of reduced time-domain and spatial-domain resources to be used for PDCCH monitoring, thereby improving power savings benefits at the UE 120 associated with PDCCH monitoring and/or decoding while enabling flexibility to adapt to changing channel conditions and/or traffic conditions.

In some aspects, by using a reduced quantity of Rx/Tx ports for purposes of PDCCH monitoring, the UE 120 may be capable of reducing communication errors and/or latency associated with using a PDCCH skip indication, such as the PDCCH skip indication described above in connection with FIGS. 3A-3H. For example, in examples in which the UE 120 is indicated to perform PDCCH skipping rather than PDCCH monitoring using a reduced quantity of Rx ports, if burst traffic arrives at the network node 110, the network node 110 may need to wait until a skip duration (e.g., skip duration 309) has elapsed to indicate to the UE 120 that there is downlink traffic for the UE 120, thus resulting in high latency. On the other hand, if the UE 120 is indicated to perform PDCCH monitoring using a reduced quantity of Rx ports as described above, the UE 120 may be capable of immediately receiving PDCCH communications associated with bursty traffic and/or may be capable of adjusting UE operations, accordingly. For example, if the UE 120 receives a PDCCH communication using a reduced quantity of Rx ports, the UE 120 may identify, based at least in part on the PDCCH communication, that a quantity of layers associated with a downlink communication that is scheduled to be received by the UE 120 is greater than the quantity of Rx ports being used by the UE 120, and the UE 120 may thus activate a quantity of Rx ports corresponding to the quantity of layers associated with the downlink communication to receive the traffic with low latency. For example, if the UE 120 is using one Rx port for PDCCH monitoring and the UE 120 determines that there is a four-layer PDSCH scheduled in the current slot, the UE 120 may activate four Rx ports to decode a PDCCH retransmission and/or to receive the four-layer PDSCH communication.

FIG. 4C shows an example 445 of UE behavior when the UE 120 receives a Rx/Tx port quantity indication, a downlink control channel skip indication, and/or an SSSG indication/switch indication (e.g., via the signaling described above in connection with reference number 430). In some aspects, the UE 120 may receive a Rx/Tx port quantity indication, a downlink control channel skip indication, and/or an SSSG indication/switch indication in combination, such as by receiving a codepoint that jointly indicates the Rx/Tx port quantity indication, the downlink control channel skip indication, and the SSSG indication/switch indication. For example, the network node 110 may jointly signal the Rx/Tx port quantity indication, the downlink control channel skip indication, and/or the SSSG indication/switch indication using a codepoint that includes three or more bits.

In such aspects, in addition to the two bits shown as either a “1” or a “0” in connection with the various arrows in FIG. 4C, the codepoint may include an additional x bits, where x≥1. In some aspects, the additional x bits may be set to a specific value (shown as “Y” in FIG. 4C) that jointly indicates an Rx/Tx port quantity to be used for PDCCH monitoring and/or a quantity of time intervals (e.g., slots) during which to use the indicated Rx/Tx port quantity for PDCCH monitoring. In this way, the UE 120 may identify which SSSG is to be used and/or switched to and/or whether PDCCH skipping is to be performed based at least in part on the two least significant bits (LSBs) of the codepoint (e.g., in a similar manner as described above in connection with FIG. 3H), and the UE 120 may further identify a quantity of Rx/Tx ports to be used for PDCCH monitoring and/or a corresponding time interval to use the quantity of Rx/Tx ports based at least in part on the x most significant bits (MSBs) of the codepoint, among other examples.

More particularly, by default the UE 120 may monitor SSSG #0. If, while monitoring SSSG #0, the UE receives a scheduling DCI in which the indication field indicates codepoint x00, the UE may continue to monitor SSSG #0 (as shown via the arrow labeled “no change” in connection with SSSG #0). If, while monitoring SSSG #0, the UE receives a scheduling DCI in which the indication field indicates codepoint x11, the UE may skip monitoring PDCCHs for duration T (as shown via the arrow labeled “Skip, T” in connection with SSSG #0). Moreover, the UE 120 may identify a quantity of Rx/Tx ports to be used by the UE 120 to monitor SSSG #0 and/or to use when resuming PDCCH monitoring following the skip duration, T, based at least in part on a setting of the one or more x bits. More particularly, the network node 110 may set the x bits to a certain value (e.g., Y in the aspect shown in FIG. 4C) to indicate a quantity of Rx/Tx ports to be used. Thus, if while monitoring SSSG #0, the UE receives a scheduling DCI in which the indication field indicates codepoint Y00, the UE may continue to monitor SSSG #0 (as shown via the arrow labeled “no change” in connection with SSSG #0) but may do so using a reduced quantity of Rx and/or Tx ports (e.g., the quantity indicated by Y, as shown in connection with the arrow labeled “Rx/Tx Ports”). Similarly, if while monitoring SSSG #0, the UE receives a scheduling DCI in which the indication field indicates codepoint Y11, the UE may skip monitoring PDCCHs for duration T (as shown via the arrow labeled “Skip, T” in connection with SSSG #0) and then may use the reduced quantity of Rx and/or Tx ports (e.g., the quantity indicated by Y, as shown in connection with the arrow labeled “Rx/Tx Ports”) when resuming PDCCH monitoring after the skip duration, T.

If, while monitoring SSSG #0, the UE receives a scheduling DCI in which the indication field indicates codepoint x01, the UE may switch to monitoring SSSG #1 (as shown via the arrow labeled “DCI (x01)” extending between SSSG #0 and SSSG #1). And if, while monitoring SSSG #0, the UE receives a scheduling DCI in which the indication field indicates codepoint x10, the UE may switch to monitoring SSSG #2 (as shown via the arrow labeled “DCI (x10)” extending between SSSG #0 and SSSG #2).

If, while monitoring SSSG #1, the UE receives a scheduling DCI in which the indication field indicates codepoint x01, the UE may continue to monitor SSSG #1 (as shown via the arrow labeled “no change” in connection with SSSG #1). If, while monitoring SSSG #1, the UE receives a scheduling DCI in which the indication field indicates codepoint x11, the UE may skip monitoring PDCCHs for duration T (as shown via the arrow labeled “Skip, T” in connection with SSSG #1). However, if, while monitoring SSSG #1, the UE receives a scheduling DCI in which the indication field indicates codepoint x00 and/or if a timer expires, the UE may switch to monitoring SSSG #0 (as shown via the arrow labeled “DCI (x00) Timer” extending between SSSG #1 and SSSG #0). On the other hand, if, while monitoring SSSG #1, the UE receives a scheduling DCI in which the indication field indicates codepoint x10, the UE may switch to monitoring SSSG #2 (as shown via the arrow labeled “DCI (x10)” extending between SSSG #1 and SSSG #2).

Moreover, if while monitoring SSSG #1, the UE receives a scheduling DCI in which the indication field indicates codepoint Y01, the UE may continue to monitor SSSG #1 (as shown via the arrow labeled “no change” in connection with SSSG #1) but may do so a reduced quantity of Rx and/or Tx ports (e.g., the quantity indicated by Y, as shown in connection with the arrow labeled “Rx/Tx Ports”). Similarly, if while monitoring SSSG #1, the UE receives a scheduling DCI in which the indication field indicates codepoint Y11, the UE may skip monitoring PDCCHs for duration T (as shown via the arrow labeled “Skip, T” in connection with SSSG #1) and then may use the reduced quantity of Rx and/or Tx ports (e.g., the quantity indicated by Y, as shown in connection with the arrow labeled “Rx/Tx Ports”) when resuming PDCCH monitoring after the skip duration, T.

Similarly, if, while monitoring SSSG #2, the UE receives a scheduling DCI in which the indication field indicates codepoint x10, the UE may continue to monitor SSSG #2 (as shown via the arrow labeled “no change” in connection with SSSG #2). If, while monitoring SSSG #2, the UE receives a scheduling DCI in which the indication field indicates codepoint x11, the UE may skip monitoring PDCCHs for duration T (as shown via the arrow labeled “Skip, T” in connection with SSSG #2). However, if, while monitoring SSSG #2, the UE receives a scheduling DCI in which the indication field indicates codepoint x00 and/or if a timer expires, the UE may switch to monitoring SSSG #0 (as shown via the arrow labeled “DCI (00) Timer” extending between SSSG #2 and SSSG #0). On the other hand, if, while monitoring SSSG #2, the UE receives a scheduling DCI in which the indication field indicates codepoint x01, the UE may switch to monitoring SSSG #1 (as shown via the arrow labeled “DCI (x01)” extending between SSSG #2 and SSSG #1).

Moreover, if while monitoring SSSG #2, the UE receives a scheduling DCI in which the indication field indicates codepoint Y10, the UE may continue to monitor SSSG #0 (as shown via the arrow labeled “no change” in connection with SSSG #0) but may do so a reduced quantity of Rx and/or Tx ports (e.g., the quantity indicated by Y, as shown in connection with the arrow labeled “Rx/Tx Ports”). Similarly, if while monitoring SSSG #0, the UE receives a scheduling DCI in which the indication field indicates codepoint Y11, the UE may skip monitoring PDCCHs for duration T (as shown via the arrow labeled “Skip, T” in connection with SSSG #0) and then may use the reduced quantity of Rx and/or Tx ports (e.g., the quantity indicated by Y, as shown in connection with the arrow labeled “Rx/Tx Ports”) when resuming PDCCH monitoring after the skip duration, T.

Based at least in part on the network node 110 signaling to the UE 120 a Rx/Tx port quantity indication (alone or in combination with a downlink control channel skip indication and/or an SSSG indication/switch indication), the UE 120 and/or the network node 110 may conserve computing, power, network, and/or communication resources that may have otherwise been consumed traditional selective PDCCH monitoring processes. For example, based at least in part on the network node 110 signaling to the UE 120 a Rx/Tx port quantity indication (alone or in combination with a downlink control channel skip indication and/or an SSSG indication/switch indication), the UE 120 may more flexibly adapt PDCCH monitoring behavior to traffic and/or channel conditions, resulting in the UE 120 and the network node 110 communicating with a reduced error rate, which may conserve computing, power, network, and/or communication resources that may have otherwise been consumed to detect and/or correct communication errors.

As indicated above, FIG. 4A-4C is provided as an example. Other examples may differ from what is described with respect to FIG. 4A-4C.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with a Rx/Tx port quantity indication.

As shown in FIG. 5, in some aspects, process 500 may include receiving a receive/transmit port quantity indication, wherein the receive/transmit port quantity indication indicates at least one of: a first quantity of receive ports to be used for monitoring a downlink control channel, or a second quantity of time intervals during which the first quantity of receive ports are to be used for monitoring the downlink control channel (block 510). For example, the UE (e.g., using reception component 702 and/or communication manager 706, depicted in FIG. 7) may receive a receive/transmit port quantity indication, wherein the receive/transmit port quantity indication indicates at least one of: a first quantity of receive ports to be used for monitoring a downlink control channel, or a second quantity of time intervals during which the first quantity of receive ports are to be used for monitoring the downlink control channel, as described above.

As further shown in FIG. 5, in some aspects, process 500 may include monitoring the downlink control channel based at least in part on the receive/transmit port quantity indication (block 520). For example, the UE (e.g., using communication manager 706, depicted in FIG. 7) may monitor the downlink control channel based at least in part on the receive/transmit port quantity indication, as described above.

Process 500 may include additional aspects, such as any single aspect or any combination of aspects described below and/or in connection with one or more other processes described elsewhere herein.

In a first aspect, process 500 includes receiving, in combination with the receive/transmit port quantity indication, at least one of a downlink control channel skip indication or an SSSG indication/switch indication, wherein the downlink control channel skip indicates a third quantity of time intervals to be skipped when monitoring the downlink control channel, and wherein the SSSG indication/switch indication indicates an SSSG to be used or switched to when monitoring the downlink control channel.

In a second aspect, alone or in combination with the first aspect, the receive/transmit port quantity indication and the at least one of the downlink control channel skip indication or the SSSG indication/switch indication are associated with at least one of a downlink control information message, a MAC-CE, or an expiration of a timer.

In a third aspect, alone or in combination with one or more of the first and second aspects, process 500 includes transmitting capability information indicating UE support for receiving the receive/transmit port quantity indication alone or in combination with a downlink control channel skip indication and an SSSG indication/switch indication.

In a fourth aspect, alone or in combination with one or more of the first through third aspects, the capability information further indicates UE support for receiving the receive/transmit port quantity indication in combination with at least one of the downlink control channel skip indication, or the SSSG indication/switch indication.

In a fifth aspect, alone or in combination with one or more of the first through fourth aspects, process 500 includes receiving configuration information that indicates at least one of enablement of the receive/transmit port quantity indication, one or more candidate quantities of receive ports to be signaled by the receive/transmit port quantity indication, or one or more candidate quantities of time intervals to be signaled by the receive/transmit port quantity indication.

In a sixth aspect, alone or in combination with one or more of the first through fifth aspects, the configuration information further indicates at least one of enablement of a downlink control channel skip indication in combination with the receive/transmit port quantity indication, one or more candidate quantities of time intervals to be signaled by the downlink control channel skip indication, enablement of an SSSG indication/switch indication in combination with the receive/transmit port quantity indication, or one or more candidate SSSGs to be signaled by the SSSG indication/switch indication.

In a seventh aspect, alone or in combination with one or more of the first through sixth aspects, the receive/transmit port quantity indication indicates the first quantity of receive ports and the second quantity of time intervals by indicating a codepoint that jointly encodes the first quantity of receive ports and the second quantity of time intervals.

In an eighth aspect, alone or in combination with one or more of the first through seventh aspects, the codepoint further encodes at least one of a third quantity of time intervals to be skipped when monitoring the downlink control channel, or a search space set group to be used or switched to for monitoring the downlink control channel.

In a ninth aspect, alone or in combination with one or more of the first through eighth aspects, the receive/transmit port quantity indication is received via a DCI message that indicates the codepoint via a downlink control channel skipping indication associated with the DCI message.

In a tenth aspect, alone or in combination with one or more of the first through ninth aspects, the receive/transmit port quantity indication is received via a MAC-CE that indicates the codepoint via a logical channel identifier associated with the MAC-CE.

In an eleventh aspect, alone or in combination with one or more of the first through tenth aspects, process 500 includes receiving a first downlink control communication based at least in part on monitoring the downlink control channel, identifying, based at least in part on the first downlink control communication, that a third quantity of downlink data communications are scheduled to be received by the UE, wherein the third quantity is greater than the first quantity, and using the third quantity of receive ports to receive a third quantity of downlink control communications associated with the third quantity of data communications.

In a twelfth aspect, alone or in combination with one or more of the first through eleventh aspects, process 500 includes transmitting a UE preference indication that indicates of at least one of a preferred quantity of receive ports to be used for monitoring the downlink control channel, or a preferred quantity of time intervals during which the preferred quantity of receive ports are to be used for monitoring the downlink control channel.

In a thirteenth aspect, alone or in combination with one or more of the first through twelfth aspects, the UE preference indication further indicates a preference for receiving, in combination, one or more of the receive/transmit port quantity indication, a downlink control channel skip indication, or a search space set group indication/switch indication.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with a Rx/Tx quantity indication.

As shown in FIG. 6, in some aspects, process 600 may include transmitting, to a UE, a receive/transmit port quantity indication, wherein the receive/transmit port quantity indication indicates at least one of: a first quantity of receive ports to be used by the UE for monitoring a downlink control channel, or a second quantity of time intervals during which the first quantity of receive ports are to be used by the UE for monitoring the downlink control channel (block 610). For example, the network node (e.g., using transmission component 804 and/or communication manager 806, depicted in FIG. 8) may transmit, to a UE, a receive/transmit port quantity indication, wherein the receive/transmit port quantity indication indicates at least one of: a first quantity of receive ports to be used by the UE for monitoring a downlink control channel, or a second quantity of time intervals during which the first quantity of receive ports are to be used by the UE for monitoring the downlink control channel, as described above.

As further shown in FIG. 6, in some aspects, process 600 may include transmitting, to the UE, one or more downlink control communications using the downlink control channel (block 620). For example, the network node (e.g., using transmission component 804 and/or communication manager 806, depicted in FIG. 8) may transmit, to the UE, one or more downlink control communications using the downlink control channel, as described above.

Process 600 may include additional aspects, such as any single aspect or any combination of aspects described below and/or in connection with one or more other processes described elsewhere herein.

In a first aspect, process 600 includes transmitting, to the UE in combination with the receive/transmit port quantity indication, at least one of a downlink control channel skip indication or an SSSG indication/switch indication, wherein the downlink control channel skip indicates a third quantity of time intervals to be skipped when monitoring the downlink control channel, and wherein the SSSG indication/switch indication indicates an SSSG to be used or switched to when monitoring the downlink control channel.

In a second aspect, alone or in combination with the first aspect, the receive/transmit port quantity indication and the at least one of the downlink control channel skip indication or the SSSG indication/switch indication are associated with at least one of a downlink control information message, a MAC-CE, or an expiration of a timer.

In a third aspect, alone or in combination with one or more of the first and second aspects, process 600 includes receiving, from the UE, capability information indicating UE support for receiving the receive/transmit port quantity indication alone or in combination with a downlink control channel skip indication and an SSSG indication/switch indication.

In a fourth aspect, alone or in combination with one or more of the first through third aspects, the capability information further indicates UE support for receiving the receive/transmit port quantity indication in combination with at least one of the downlink control channel skip indication, or the SSSG indication/switch indication.

In a fifth aspect, alone or in combination with one or more of the first through fourth aspects, process 600 includes transmitting, to the UE, configuration information that indicates at least one of enablement of the receive/transmit port quantity indication, one or more candidate quantities of receive ports to be signaled by the receive/transmit port quantity indication, or one or more candidate quantities of time intervals to be signaled by the receive/transmit port quantity indication.

In a sixth aspect, alone or in combination with one or more of the first through fifth aspects, the configuration information further indicates at least one of enablement of a downlink control channel skip indication in combination with the receive/transmit port quantity indication, one or more candidate quantities of time intervals to be signaled by the downlink control channel skip indication, enablement of an SSSG indication/switch indication in combination with the receive/transmit port quantity indication, or one or more candidate SSSGs to be signaled by the SSSG indication/switch indication.

In a seventh aspect, alone or in combination with one or more of the first through sixth aspects, the receive/transmit port quantity indication indicates the first quantity of receive ports and the second quantity of time intervals by indicating a codepoint that jointly encodes the first quantity of receive ports and the second quantity of time intervals.

In an eighth aspect, alone or in combination with one or more of the first through seventh aspects, the codepoint further encodes at least one of a third quantity of time intervals to be skipped by the UE when monitoring the downlink control channel, or a search space set group to be used or switched to by the UE for monitoring the downlink control channel.

In a ninth aspect, alone or in combination with one or more of the first through eighth aspects, the receive/transmit port quantity indication is transmitted via a DCI message that indicates the codepoint via a downlink control channel skipping indication associated with the DCI message.

In a tenth aspect, alone or in combination with one or more of the first through ninth aspects, the receive/transmit port quantity indication is transmitted via a MAC-CE that indicates the codepoint via a logical channel identifier associated with the MAC-CE.

In an eleventh aspect, alone or in combination with one or more of the first through tenth aspects, process 600 includes receiving, from the UE, a UE preference indication that indicates of at least one of a preferred quantity of receive ports to be used for monitoring the downlink control channel, or a preferred quantity of time intervals during which the preferred quantity of receive ports are to be used for monitoring the downlink control channel.

In a twelfth aspect, alone or in combination with one or more of the first through eleventh aspects, the UE preference indication further indicates a preference for receiving, in combination, one or more of the receive/transmit port quantity indication, a downlink control channel skip indication, or a search space set group indication/switch indication.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4C. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE 120 described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE 120 described above in connection with FIG. 1, such as a radio, one or more RF chains, one or more transceivers, or one or more modems, each of which may in turn be coupled with one or more antennas of the UE 120.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive a receive/transmit port quantity indication, wherein the receive/transmit port quantity indication indicates at least one of a first quantity of receive ports to be used for monitoring a downlink control channel, or a second quantity of time intervals during which the first quantity of receive ports are to be used for monitoring the downlink control channel. The communication manager 706 may monitor the downlink control channel based at least in part on the receive/transmit port quantity indication.

The reception component 702 may receive, in combination with the receive/transmit port quantity indication, at least one of a downlink control channel skip indication, wherein the downlink control channel skip indicates a third quantity of time intervals to be skipped when monitoring the downlink control channel, or an SSSG indication/switch indication, wherein the SSSG indication/switch indication indicates an SSSG to be used or switched to when monitoring the downlink control channel.

The transmission component 704 may transmit capability information indicating UE support for receiving the receive/transmit port quantity indication alone or in combination with a downlink control channel skip indication and an SSSG indication/switch indication.

The reception component 702 may receive configuration information that indicates at least one of enablement of the receive/transmit port quantity indication, one or more candidate quantities of receive ports to be signaled by the receive/transmit port quantity indication, or one or more candidate quantities of time intervals to be signaled by the receive/transmit port quantity indication.

The reception component 702 may receive a first downlink control communication based at least in part on monitoring the downlink control channel.

The communication manager 706 may identify, based at least in part on the first downlink control communication, that a third quantity of downlink data communications are scheduled to be received by the UE, wherein the third quantity is greater than the first quantity.

The communication manager 706 may use the third quantity of receive ports to receive a third quantity of downlink control communications associated with the third quantity of data communications.

The transmission component 704 may transmit a UE preference indication that indicates of at least one of a preferred quantity of receive ports to be used for monitoring the downlink control channel, or a preferred quantity of time intervals during which the preferred quantity of receive ports are to be used for monitoring the downlink control channel.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4C. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node 110 described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to a UE, a receive/transmit port quantity indication, wherein the receive/transmit port quantity indication indicates at least one of a first quantity of receive ports to be used by the UE for monitoring a downlink control channel, or a second quantity of time intervals during which the first quantity of receive ports are to be used by the UE for monitoring the downlink control channel. The transmission component 804 may transmit, to the UE, one or more downlink control communications using the downlink control channel.

The transmission component 804 may transmit, to the UE in combination with the receive/transmit port quantity indication, at least one of a downlink control channel skip indication, wherein the downlink control channel skip indicates a third quantity of time intervals to be skipped when monitoring the downlink control channel, or an SSSG indication/switch indication, wherein the SSSG indication/switch indication indicates an SSSG to be used or switched to when monitoring the downlink control channel.

The reception component 802 may receive, from the UE, capability information indicating UE support for receiving the receive/transmit port quantity indication alone or in combination with a downlink control channel skip indication and an SSSG indication/switch indication.

The transmission component 804 may transmit, to the UE, configuration information that indicates at least one of enablement of the receive/transmit port quantity indication, one or more candidate quantities of receive ports to be signaled by the receive/transmit port quantity indication, or one or more candidate quantities of time intervals to be signaled by the receive/transmit port quantity indication.

The reception component 802 may receive, from the UE, a UE preference indication that indicates of at least one of a preferred quantity of receive ports to be used for monitoring the downlink control channel, or a preferred quantity of time intervals during which the preferred quantity of receive ports are to be used for monitoring the downlink control channel.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving a receive/transmit port quantity indication, wherein the receive/transmit port quantity indication indicates at least one of: a first quantity of receive ports to be used for monitoring a downlink control channel, or a second quantity of time intervals during which the first quantity of receive ports are to be used for monitoring the downlink control channel; and monitoring the downlink control channel based at least in part on the receive/transmit port quantity indication.
Aspect 2: The method of Aspect 1, further comprising receiving, in combination with the receive/transmit port quantity indication, at least one of: a downlink control channel skip indication or a search space set group (SSSG) indication/switch indication, wherein the downlink control channel skip indicates a third quantity of time intervals to be skipped when monitoring the downlink control channel, and wherein the SSSG indication/switch indication indicates an SSSG to be used or switched to when monitoring the downlink control channel.
Aspect 3: The method of Aspect 2, wherein the receive/transmit port quantity indication and the at least one of the downlink control channel skip indication or the SSSG indication/switch indication are associated with at least one of: a downlink control information message, a medium access control (MAC) control element (MAC-CE), or an expiration of a timer.
Aspect 4: The method of any of Aspects 1-3, further comprising transmitting capability information indicating UE support for receiving the receive/transmit port quantity indication alone or in combination with a downlink control channel skip indication and a search space set group (SSSG) indication/switch indication.
Aspect 5: The method of Aspect 4, wherein the capability information further indicates UE support for receiving the receive/transmit port quantity indication in combination with at least one of: the downlink control channel skip indication, or the SSSG indication/switch indication.
Aspect 6: The method of any of Aspects 1-5, further comprising receiving configuration information that indicates at least one of: enablement of the receive/transmit port quantity indication, one or more candidate quantities of receive ports to be signaled by the receive/transmit port quantity indication, or one or more candidate quantities of time intervals to be signaled by the receive/transmit port quantity indication.
Aspect 7: The method of Aspect 6, wherein the configuration information further indicates at least one of: enablement of a downlink control channel skip indication in combination with the receive/transmit port quantity indication, one or more candidate quantities of time intervals to be signaled by the downlink control channel skip indication, enablement of a search space set group (SSSG) indication/switch indication in combination with the receive/transmit port quantity indication, or one or more candidate SSSGs to be signaled by the SSSG indication/switch indication.
Aspect 8: The method of any of Aspects 1-7, wherein the receive/transmit port quantity indication indicates the first quantity of receive ports and the second quantity of time intervals by indicating a codepoint that jointly encodes the first quantity of receive ports and the second quantity of time intervals.
Aspect 9: The method of Aspect 8, wherein the codepoint further encodes at least one of: a third quantity of time intervals to be skipped when monitoring the downlink control channel, or a search space set group to be used or switched to for monitoring the downlink control channel.
Aspect 10: The method of Aspect 9, wherein the receive/transmit port quantity indication is received via a downlink control information (DCI) message that indicates the codepoint via a downlink control channel skipping indication associated with the DCI message.
Aspect 11: The method of Aspect 9, wherein the receive/transmit port quantity indication is received via a medium access control (MAC) control element (MAC-CE) that indicates the codepoint via a logical channel identifier associated with the MAC-CE.
Aspect 12: The method of any of Aspects 1-11, further comprising: receiving a first downlink control communication based at least in part on monitoring the downlink control channel; identifying, based at least in part on the first downlink control communication, that a third quantity of downlink data communications are scheduled to be received by the UE, wherein the third quantity is greater than the first quantity; and using the third quantity of receive ports to receive a third quantity of downlink control communications associated with the third quantity of data communications.
Aspect 13: The method of any of Aspects 1-12, further comprising transmitting a UE preference indication that indicates of at least one of: a preferred quantity of receive ports to be used for monitoring the downlink control channel, or a preferred quantity of time intervals during which the preferred quantity of receive ports are to be used for monitoring the downlink control channel.
Aspect 14: The method of Aspect 13, wherein the UE preference indication further indicates a preference for receiving, in combination, one or more of the receive/transmit port quantity indication, a downlink control channel skip indication, or a search space set group indication/switch indication.
Aspect 15: A method of wireless communication performed by a network node, comprising: transmitting, to a user equipment (UE), a receive/transmit port quantity indication, wherein the receive/transmit port quantity indication indicates at least one of: a first quantity of receive ports to be used by the UE for monitoring a downlink control channel, or a second quantity of time intervals during which the first quantity of receive ports are to be used by the UE for monitoring the downlink control channel; and transmitting, to the UE, one or more downlink control communications using the downlink control channel.
Aspect 16: The method of Aspect 15, further comprising transmitting, to the UE in combination with the receive/transmit port quantity indication, at least one of: a downlink control channel skip indication or a search space set group (SSSG) indication/switch indication, wherein the downlink control channel skip indicates a third quantity of time intervals to be skipped when monitoring the downlink control channel, and wherein the SSSG indication/switch indication indicates an SSSG to be used or switched to when monitoring the downlink control channel.
Aspect 17: The method of Aspect 16, wherein the receive/transmit port quantity indication and the at least one of the downlink control channel skip indication or the SSSG indication/switch indication are associated with at least one of: a downlink control information message, a medium access control (MAC) control element (MAC-CE), or an expiration of a timer.
Aspect 18: The method of any of Aspects 15-17, further comprising receiving, from the UE, capability information indicating UE support for receiving the receive/transmit port quantity indication alone or in combination with a downlink control channel skip indication and a search space set group (SSSG) indication/switch indication.
Aspect 19: The method of Aspect 18, wherein the capability information further indicates UE support for receiving the receive/transmit port quantity indication in combination with at least one of: the downlink control channel skip indication, or the SSSG indication/switch indication.
Aspect 20: The method of any of Aspects 15-19, further comprising transmitting, to the UE, configuration information that indicates at least one of: enablement of the receive/transmit port quantity indication, one or more candidate quantities of receive ports to be signaled by the receive/transmit port quantity indication, or one or more candidate quantities of time intervals to be signaled by the receive/transmit port quantity indication.
Aspect 21: The method of Aspect 20, wherein the configuration information further indicates at least one of: enablement of a downlink control channel skip indication in combination with the receive/transmit port quantity indication, one or more candidate quantities of time intervals to be signaled by the downlink control channel skip indication, enablement of a search space set group (SSSG) indication/switch indication in combination with the receive/transmit port quantity indication, or one or more candidate SSSGs to be signaled by the SSSG indication/switch indication.
Aspect 22: The method of any of Aspects 15-21, wherein the receive/transmit port quantity indication indicates the first quantity of receive ports and the second quantity of time intervals by indicating a codepoint that jointly encodes the first quantity of receive ports and the second quantity of time intervals.
Aspect 23: The method of Aspect 22, wherein the codepoint further encodes at least one of: a third quantity of time intervals to be skipped by the UE when monitoring the downlink control channel, or a search space set group to be used or switched to by the UE for monitoring the downlink control channel.
Aspect 24: The method of Aspect 23, wherein the receive/transmit port quantity indication is transmitted via a downlink control information (DCI) message that indicates the codepoint via a downlink control channel skipping indication associated with the DCI message.
Aspect 25: The method of Aspect 23, wherein the receive/transmit port quantity indication is transmitted via a medium access control (MAC) control element (MAC-CE) that indicates the codepoint via a logical channel identifier associated with the MAC-CE.
Aspect 26: The method of any of Aspects 15-25, further comprising receiving, from the UE, a UE preference indication that indicates of at least one of: a preferred quantity of receive ports to be used for monitoring the downlink control channel, or a preferred quantity of time intervals during which the preferred quantity of receive ports are to be used for monitoring the downlink control channel.
Aspect 27: The method of Aspect 26, wherein the UE preference indication further indicates a preference for receiving, in combination, one or more of the receive/transmit port quantity indication, a downlink control channel skip indication, or a search space set group indication/switch indication.
Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.
Aspect 29: An apparatus for wireless communication at a device, the apparatus comprising one or more memories and one or more processors coupled to the one or more memories, the one or more processors configured to cause the device to perform the method of one or more of Aspects 1-27.
Aspect 30: An apparatus for wireless communication, the apparatus comprising at least one means for performing the method of one or more of Aspects 1-27.
Aspect 31: A non-transitory computer-readable medium storing code for wireless communication, the code comprising instructions executable by one or more processors to perform the method of one or more of Aspects 1-27.
Aspect 32: A non-transitory computer-readable medium storing a set of instructions for wireless communication, the set of instructions comprising one or more instructions that, when executed by one or more processors of a device, cause the device to perform the method of one or more of Aspects 1-27.
Aspect 33: A device for wireless communication, the device comprising a processing system that includes one or more processors and one or more memories coupled with the one or more processors, the processing system configured to cause the device to perform the method of one or more of Aspects 1-27.
Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories and configured to cause the UE to:
receive a receive/transmit port quantity indication, wherein the receive/transmit port quantity indication indicates at least one of:
a first quantity of receive ports to be used for monitoring a downlink control channel, or
a second quantity of time intervals during which the first quantity of receive ports are to be used for monitoring the downlink control channel; and
monitor the downlink control channel based at least in part on the receive/transmit port quantity indication.

2. The UE of claim 1, wherein the one or more processors are further configured to cause the UE to receive, in combination with the receive/transmit port quantity indication, at least one of a downlink control channel skip or a search space set group (SSSG) indication/switch indication,
wherein the downlink control channel skip indicates a third quantity of time intervals to be skipped when monitoring the downlink control channel, and
wherein the SSSG indication/switch indication indicates an SSSG to be used or switched to when monitoring the downlink control channel.

3. The UE of claim 2, wherein the receive/transmit port quantity indication and the at least one of the downlink control channel skip indication or the SSSG indication/switch indication are associated with at least one of:
a downlink control information message,
a medium access control (MAC) control element (MAC-CE), or
an expiration of a timer.

4. The UE of claim 1, wherein the one or more processors are further configured to cause the UE to transmit capability information indicating UE support for receiving the receive/transmit port quantity indication alone or in combination with a downlink control channel skip indication and a search space set group (SSSG) indication/switch indication.

5. The UE of claim 4, wherein the capability information further indicates UE support for receiving the receive/transmit port quantity indication in combination with at least one of:
the downlink control channel skip indication, or
the SSSG indication/switch indication.

6. The UE of claim 1, wherein the one or more processors are further configured to cause the UE to receive configuration information that indicates at least one of:
enablement of the receive/transmit port quantity indication,
one or more candidate quantities of receive ports to be signaled by the receive/transmit port quantity indication, or
one or more candidate quantities of time intervals to be signaled by the receive/transmit port quantity indication.

7. The UE of claim 6, wherein the configuration information further indicates at least one of:
enablement of a downlink control channel skip indication in combination with the receive/transmit port quantity indication,
one or more candidate quantities of time intervals to be signaled by the downlink control channel skip indication,
enablement of a search space set group (SSSG) indication/switch indication in combination with the receive/transmit port quantity indication, or
one or more candidate SSSGs to be signaled by the SSSG indication/switch indication.

8. The UE of claim 1, wherein the receive/transmit port quantity indication indicates the first quantity of receive ports and the second quantity of time intervals by indicating a codepoint that jointly encodes the first quantity of receive ports and the second quantity of time intervals.

9. The UE of claim 8, wherein the codepoint further encodes at least one of:
a third quantity of time intervals to be skipped when monitoring the downlink control channel, or
a search space set group to be used or switched to for monitoring the downlink control channel.

10. The UE of claim 9, wherein the receive/transmit port quantity indication is received via a downlink control information (DCI) message that indicates the codepoint via a downlink control channel skipping indication associated with the DCI message.

11. The UE of claim 9, wherein the receive/transmit port quantity indication is received via a medium access control (MAC) control element (MAC-CE) that indicates the codepoint via a logical channel identifier associated with the MAC-CE.

12. The UE of claim 1, wherein the one or more processors are further configured to cause the UE to:
receive a first downlink control communication based at least in part on monitoring the downlink control channel;
identify, based at least in part on the first downlink control communication, that a third quantity of downlink data communications are scheduled to be received by the UE, wherein the third quantity is greater than the first quantity; and
use the third quantity of receive ports to receive a third quantity of downlink control communications associated with the third quantity of data communications.

13. The UE of claim 1, wherein the one or more processors are further configured to cause the UE to transmit a UE preference indication that indicates of at least one of:
a preferred quantity of receive ports to be used for monitoring the downlink control channel, or
a preferred quantity of time intervals during which the preferred quantity of receive ports are to be used for monitoring the downlink control channel.

14. The UE of claim 13, wherein the UE preference indication further indicates a preference for receiving, in combination, one or more of the receive/transmit port quantity indication, a downlink control channel skip indication, or a search space set group indication/switch indication.

15. A network node for wireless communication, comprising:
one or more memories; and
one or more processors coupled to the one or more memories and configured to cause the network node to:
transmit, to a user equipment (UE), a receive/transmit port quantity indication, wherein the receive/transmit port quantity indication indicates at least one of:
a first quantity of receive ports to be used by the UE for monitoring a downlink control channel, or
a second quantity of time intervals during which the first quantity of receive ports are to be used by the UE for monitoring the downlink control channel; and
transmit, to the UE, one or more downlink control communications using the downlink control channel.

16. The network node of claim 15, wherein the one or more processors are further configured to cause the network node to transmit, to the UE in combination with the receive/transmit port quantity indication, at least one of a downlink control channel skip indication or a search space set group (SSSG) indication/switch indication,
wherein the downlink control channel skip indicates a third quantity of time intervals to be skipped when monitoring the downlink control channel, and
wherein the SSSG indication/switch indication indicates an SSSG to be used or switched to when monitoring the downlink control channel.

17. The network node of claim 15, wherein the one or more processors are further configured to cause the network node to transmit, to the UE, configuration information that indicates at least one of:
enablement of the receive/transmit port quantity indication,
one or more candidate quantities of receive ports to be signaled by the receive/transmit port quantity indication, or
one or more candidate quantities of time intervals to be signaled by the receive/transmit port quantity indication.

18. The network node of claim 17, wherein the configuration information further indicates at least one of:
enablement of a downlink control channel skip indication in combination with the receive/transmit port quantity indication,
one or more candidate quantities of time intervals to be signaled by the downlink control channel skip indication,
enablement of a search space set group (SSSG) indication/switch indication in combination with the receive/transmit port quantity indication, or
one or more candidate SSSGs to be signaled by the SSSG indication/switch indication.

19. A method of wireless communication performed by a user equipment (UE), comprising:
receiving a receive/transmit port quantity indication, wherein the receive/transmit port quantity indication indicates at least one of:
a first quantity of receive ports to be used for monitoring a downlink control channel, or
a second quantity of time intervals during which the first quantity of receive ports are to be used for monitoring the downlink control channel; and
monitoring the downlink control channel based at least in part on the receive/transmit port quantity indication.

20. The method of claim 19, further comprising receiving, in combination with the receive/transmit port quantity indication, at least one of a downlink control channel skip indication or a search space set group (SSSG) indication/switch indication,
wherein the downlink control channel skip indicates a third quantity of time intervals to be skipped when monitoring the downlink control channel, and
wherein the SSSG indication/switch indication indicates an SSSG to be used or switched to when monitoring the downlink control channel.
